(19) United States
(12) Patent Application Publication
(10) Pub. No.: US 2023/0285215 A1
(43) Pub. Date: Sep. 14, 2023

(54) DENTAL WATER SUPPLY SYSTEMS AND METHODS

(71) Applicant: ProEdge Dental Products, Inc., Centennial, CO (US)

(72) Inventors: Gregg A. Wicken, Broomfield, CO (US); Mark A. Frampton, Centennial, CO (US)

(21) Appl. No.: 18/119,703

(22) Filed: Mar. 9, 2023

Related U.S. Application Data
(60) Provisional application No. 63/318,089, filed on Mar. 9, 2022.
(60) Provisional application No. 63/318,093, filed on Mar. 9, 2022.

(51) Int. Cl. A61G 15/16

(52) U.S. Cl. CPC A61G 15/16

(57) ABSTRACT

A system and method for attaching a dental water supply bottle to a bottle mounting bracket associated with dental equipment. The system includes a collar configured to be attached to a neck region of a dental water supply bottle, one or more attachment openings defined by the collar, and a quick release adapter. The adapter may include one or more mounting bracket attachment slots and one or more quick release structures. Thus, the adapter can be mounted to the collar by placing the one or more quick release structures into the one or more attachment openings, and the adapter can be disengaged and removed from the collar by manually articulating the quick release structures without the use of tools. The bottle, collar, and quick release adapter may be mounted to a new or existing dental water supply mounting bracket using the mounting bracket attachment slots.

### FIELD

The present disclosure relates to systems, apparatus, and methods for supplying water to a dental workstation. The present disclosure relates more particularly to dental water bottles having improved internal accessibility, internal or external dental water bottle treatment assemblies, and adapters providing for the connection of a dental water bottle and associated apparatus to workstation bottle mounting bracket.

### BACKGROUND

Many dental or oral surgery procedures require invasion of the patient's tooth, gum, bone, vascular or other tissues. Accordingly, proper dental practice requires that significant steps be taken to prevent or minimize the risk of any infection occurring because of the dental procedure.

One of many steps taken to minimize infection occurring because of a dental procedure is the use of a dedicated dental water supply to provide the water used for any purpose within a patient's mouth.

A separate, dedicated dental water supply is typically located at each dental operatory chair or other workstation in a dental or oral surgery workspace. The water in the dental water supply is typically contained within a bottle connected by supply lines to various dental handpieces, tools, syringes, cuspidors, or other equipment. Dental water supplies are low flow systems with relatively small diameter supply lines. Environmental microorganisms will inevitably form a biofilm on system surfaces exposed to water and compromise the water supply. Therefore, steps are typically taken to minimize or eliminate biofilms and otherwise maintain acceptable water quality within the dental water supply system.

It is desirable to periodically access the elements of a dental water supply system for various maintenance tasks, including but not limited to, refilling the bottle, performing a chemical shock treatment to minimize and remove accumulated biofilms, replace water filter elements, dispensing or administering a continuously present low level antimicrobial chemical, adding compounds, or apparatus, or replacing a water bottle or other component after a specified expiration date or useful life. Some of these operations require access to structures such as water uptake tubes or filters operationally housed within or adjacent to the water bottle.

Many dental water supply systems feature a bottle having a relatively narrow opening in the neck of the bottle. Thus, it can be difficult to access the interior of such a bottle for cleaning, other maintenance, filter replacement, or similar tasks. In addition, the size and configuration of any filter element, which in use is designed to be placed within the bottle, can be constrained by the diameter of the opening passing through the bottle neck.

Thus, access to the interior of known dental water storage system bottles or filter housings, and access to associated apparatus for routine maintenance, cleaning, replacement, refilling, chemical shock treatment, or other procedures can be difficult and time-consuming, especially for dental office staff who are not specifically trained to disassemble and reassemble dental water storage systems. In addition, some bottles may not be mountable to some mounting brackets or sockets. The mentioned difficulties can also lead to improper reassembly of the components and failure of the system to perform as intended. The embodiments disclosed herein are directed toward overcoming one or more of the above problems.

### SUMMARY OF CERTAIN EMBODIMENTS

One embodiment includes a system for attaching a dental water supply bottle to a bottle mounting bracket associated with dental equipment. The system includes a collar configured to be attached to a neck region of a dental water supply bottle, one or more attachment openings defined by the collar, and a quick release adapter. The adapter may include one or more mounting bracket attachment slots and one or more quick release structures. Thus, the adapter can be mounted to the collar by placing the one or more quick release structures into the one or more attachment openings, and the adapter can be disengaged and removed from the collar by manually articulating the quick release structures without the use of tools.

In addition, the adapter can be removably mounted to the bottle mounting bracket using the mounting bracket attachment slots.

Another embodiment includes a method of attaching a dental water supply bottle to a bottle mounting bracket. The method of attaching includes providing a dental water supply bottle and an original collar assembly, removing the original collar from the dental water supply bottle, and attaching a replacement collar to the dental water supply bottle. The replacement collar may include one or more attachment openings. The method further includes providing an adapter having one or more mounting bracket attachment slots, and one or more quick release structures. The method further includes mounting the adapter to the replacement collar by placing the one or more of the quick release structures into engagement with the one or more attachment openings. Then the dental water supply bottle, replacement collar, and adapter assembly may be attached to the bottle mounting bracket by engaging the one or more bracket attachment slots with the bottle mounting bracket.

Other embodiments include a dental water supply system having a dental water bottle with an upper bottle portion and a lower bottle portion separable from the upper bottle portion. The dental water supply bottle also includes a sealed joint between the upper bottle portion and the lower bottle portion providing for the upper bottle portion to be separated from the lower bottle portion by a user. Additional embodiments include methods of securing an upper bottle portion to a lower bottle portion with a watertight seal, in some embodiments without the use of tools.

Other disclosed embodiment includes a dental water bottle as described above.

Other disclosed embodiments include dental water system treatment assemblies and methods of treating dental water system supply water. Disclosed treatment assemblies can include a lower end cap, one or more housing barrels, and a top cap, where at least one of the lower end cap, one or more housing barrels, and top cap are separable from an adjacent component without the use of tools.

Other disclosed embodiments include an external dental water treatment assembly and methods of treating a dental water supply with an external treatment assembly. The external treatment assembly embodiments include an upper engagement structure for engagement with a bottle mounting bracket, a housing, and a lower engagement structure for connection to a dental water bottle. In external treatment assembly embodiments, the housing can have a diameter greater than a diameter of the opening in the neck of the bottle.

Other embodiments include a dental water supply system having a threaded adapter as disclosed herein, which threaded adapter may include a threaded connector configured to be threadably engaged with a threaded mounting bracket of a dental apparatus, an adapter body defining a water channel and an air channel through the adapter. Threaded adapter embodiments may also include an attachment structure configured for attachment to a quick release adapter. The system also includes the quick release adapter having a mating attachment structure configured for engagement with the threaded adapter, a quick release adapter body defining a water channel and an air channel through the adapter, and a quick release mechanism, configured to mount to a dental water bottle. The system also includes the dental water bottle. In some embodiments, the dental water bottle includes an access guard configured to selectively limit or allow access to the quick release mechanism.

Other embodiments include a dental water supply system with a threaded adapter having a threaded connector configured to be threadably engaged with the threaded mounting bracket of a dental apparatus, an adapter body defining a water channel and an air channel through the adapter, an attachment structure configured for attachment directly to a dental water supply bottle, and the dental water supply bottle.

Other embodiments include a threaded adapter having a threaded connector configured to be threadably engaged with the threaded mounting bracket of a dental apparatus, an adapter body defining a water channel and an air channel through the adapter, and an attachment structure configured for attachment to a quick release adapter or a dental water supply bottle.

Other embodiments include a quick release adapter having an attachment structure configured for engagement with a threaded adapter or a dental water supply bracket, a quick release adapter body defining a water channel and an air channel through the adapter, and a quick release mechanism, configured to mount to a dental water bottle.

### BRIEF DESCRIPTION OF THE DRAWINGS

FIG. 1 is an exploded perspective view of a dental water supply system as described herein.

FIG. 2 is an exploded perspective view the bottle and treatment assembly elements of the dental water supply system of FIG. 1.

FIG. 3 is a perspective view of the upper bottle portion of the bottle of FIG. 2.

FIG. 4A is a perspective views of the upper bottle portion of FIG. 3, a treatment assembly and insert clip structures.

FIG. 4B is a bottom perspective view of the upper bottle portion of FIG. 3.

FIG. 5A is an exploded perspective view of the bottle and insert clip retaining structures of FIG. 1.

FIG. 5B is multiple views of and insert clip structure.

FIG. 6A is a perspective view of an upper bottle portion and a lower bottle portion of an alternative water supply bottle.

FIG. 6B is a perspective view of the upper bottle portion and lower bottle portion of FIG. 6A assembled together.

FIG. 7A is a front elevation view of the bottle of FIG. 6A with detail.

FIG. 7B is a center axis cross-sectional view of the bottle of FIG. 6A with detail.

FIG. 8 is a perspective view of a access guard half, with detail.

FIG. 9A is a top perspective view of a quick release bottle adapter.

FIG. 9B is a top plan view of the quick release bottle adapter of FIG. 9A.

FIG. 9C is a front elevation view of the quick release bottle adapter of FIG. 9A.

FIG. 9D is a bottom plan view of the quick release bottle adapter of FIG. 9A.

FIG. 10 is an exploded perspective view of the quick release bottle adapter of FIG. 9A mounted in the upper bottle portion of FIG. 6A with two access guard halves.

FIG. 11A is a front elevation views of an alternative bottle embodiment with an elongated cylindrical treatment assembly.

FIG. 11A is a front elevation views of the alternative bottle embodiment of FIG. 1A with a wide puck-type treatment assembly.

FIG. 12A is an operational diagram showing a first step of the assembly of the bottle of FIG. 11A with a treatment assembly.

FIG. 12B is an operational diagram showing a second step of the assembly of the bottle of FIG. 11A with a treatment assembly.

FIG. 12C is an operational diagram showing a third step of the assembly of the bottle of FIG. 11A with a treatment assembly.

FIG. 13 is an exploded perspective view of a cylindrical treatment assembly embodiment.

FIG. 14 is an exploded perspective view of an alternative cylindrical treatment assembly embodiment.

FIG. 15A is a cross-sectional view of the cylindrical treatment assembly embodiment of FIG. 13.

FIG. 15B is a front elevation view of the cylindrical treatment assembly embodiment of FIG. 13.

FIG. 15C is an exploded cross-sectional view of the cylindrical treatment assembly embodiment of FIG. 13.

FIG. 16A is an exploded perspective view of the lower end elements of the cylindrical treatment assembly embodiment of FIG. 13.

FIG. 16B is a perspective view of the end cap of the cylindrical treatment assembly embodiment of FIG. 13.

FIG. 17 is an exploded perspective view of an alternative embodiment of modular cylindrical treatment assembly.

FIG. 18A is a perspective view of the modular cylindrical treatment assembly of FIG. 17

FIG. 18B is an alternative perspective view of the modular cylindrical treatment assembly of FIG. 17

FIG. 19 is an exploded perspective view of portions of the modular cylindrical treatment assembly of FIG. 11, with two separate block filter components installed.

FIG. 20A is a perspective view of the lower end cap of the modular cylindrical treatment assembly of FIG. 17.

FIG. 20B is an alternative perspective views of the lower end cap of the modular cylindrical treatment assembly of FIG. 17.

FIG. 20C is a perspective views of the upper end cap of the modular cylindrical treatment assembly of FIG. 17.

FIG. 21 is an exploded perspective view of a modular cylindrical treatment assembly featuring a separate twist lock fitting.

FIG. 22A is a perspective view of the upper portion of the modular cylindrical treatment assembly of FIG. 21.

FIG. 22B is a perspective view of the modular cylindrical treatment assembly of FIG. 21.

FIG. 23 is a perspective view of certain elements of the modular cylindrical treatment assembly of FIG. 21

FIG. 24A is a sectional view of an alternative treatment assembly featuring an extension tube.

FIG. 24B is an exploded elevation view of the treatment assembly of FIG. 24A.

FIG. 25 is an exploded perspective view of the treatment assembly of FIG. 24A with detail.

FIG. 26A is a sectional view of an alternative treatment assembly featuring a twist lock extension.

FIG. 26B is a front elevation view of the treatment assembly of FIG. 26A.

FIG. 27 is an exploded perspective view of the treatment assembly of FIG. 26A.

FIG. 28 is an exploded front elevation view of an external puck treatment assembly configured to be mounted between a bottle mounting bracket and a water bottle.

FIG. 29 is an exploded front elevation view of an alternative external puck treatment assembly configured to be mounted between a quick-release bottle mounting bracket and a water bottle.

FIG. 30 is an exploded perspective view of a dental water supply system with a replacement collar and adapter as disclosed herein.

FIG. 31A is a front elevation view of the bottle and collar elements of the dental water supply system of FIG. 30 showing selected installation steps.

FIG. 31B is a front elevation view of the bottle and collar elements of the dental water supply system of FIG. 30 showing additional installation steps.

FIG. 32A is a front elevation view of the bottle, collar, and adapter elements of the dental water supply system of FIG. 30, illustrating the articulation of the quick release structures.

FIG. 32B is a front elevation view of the bottle, collar, and adapter elements of the dental water supply system of FIG. 30, illustrating the removal of the adapter after using the quick release structures.

FIG. 33A is a front elevation view of the bottle, collar, and adapter elements of the dental water supply system of FIG. 30, illustrating the insertion of the adapter.

FIG. 33B is a front elevation view of the bottle, collar, and adapter elements of the dental water supply system of FIG. 30 illustrating the engagement of the quick release structures after insertion of the adapter.

FIG. 34A is a front elevation view of the bottle, collar, and adapter elements of the dental water supply system of FIG. 30, illustrating the engagement and capture surfaces.

FIG. 34B is a detailed view of the collar and adapter elements of the dental water supply system of FIG. 30, illustrating the engagement and capture surfaces in a first configuration.

FIG. 34C is a detailed view of the collar and adapter elements of the dental water supply system of FIG. 30, illustrating the engagement and capture surfaces in a second configuration.

FIG. 35A is a partial perspective view of an alternative embodiment of quick release adapter, collar, and bottle elements.

FIG. 35B is a partial perspective view of the of quick release adapter, collar, and bottle elements of FIG. 35B during filling operations.

FIG. 36A is a perspective view of the bottle, collar, and quick release adapter head elements of the dental water supply system of FIG. 30, featuring an exterior safety guard position to provide access to the quick release mechanism.

FIG. 36B is a perspective view of the bottle, collar, and quick release adapter head elements of the dental water supply system of FIG. 30, featuring an exterior safety guard position to prohibit access to the quick release mechanism.

FIG. 37 is an exploded perspective view of an alternative embodiment of dental water supply system with replacement collar and adapter as disclosed herein.

FIG. 38A is a front elevation view an adapter showing the attachment of a treatment assembly.

FIG. 38B is a front elevation view of an adapter showing additional steps in the attachment of a treatment assembly.

FIG. 38C is a front elevation view an adapter and treatment assembly being installed in a bottle and replacement collar assembly.

FIG. 39A is a front elevation view an adapter showing the removal of a treatment assembly.

FIG. 39B is a front elevation view an adapter showing additional steps in the removal of a treatment assembly.

FIG. 39C is a front elevation view an adapter showing the installation of a alternative treatment assembly.

FIG. 39D is a front elevation view an adapter, treatment, replacement collar, and bottle assembly being installed in a bottle mounting bracket.

FIG. 40 is an exploded perspective view of an alternative dental water supply bottle and threaded adapter.

FIG. 41 is an exploded perspective view of the dental water supply bottle and threaded adapter of FIG. 40 and a female socket assembly associated with dental equipment.

FIG. 42 is a cross section view of the threaded adapter of FIG. 40

FIG. 43A is a front elevation view of the threaded adapter of FIG. 40 being mounted to a female socket assembly.

FIG. 43B is a cross section view of the threaded adapter of FIG. 40 being mounted to a female socket assembly.

FIG. 43C is a front elevation view of additional steps of the threaded adapter of FIG. 40 being mounted to a female socket assembly.

FIG. 44A is a perspective view of the threaded adapter and female socket assembly of FIG. 41, showing the water supply line attached and positioned within the threaded adapter and adapter attached to the female socket assembly.

FIG. 44B is a perspective view of the threaded adapter and female socket assembly of FIG. 41, showing additional steps in the attachment of a water supply line.

FIG. 44C is a perspective view of the threaded adapter and female socket assembly of FIG. 41, showing initial steps in the attachment of a water supply line.

FIG. 44D is a cross section view of the threaded adapter and female socket assembly of FIG. 41, showing the water supply line attached and positioned within the threaded adapter and adapter attached to the female socket assembly.

FIG. 44E is a perspective view of the threaded adapter and female socket assembly of FIG. 41, showing the water supply line attached and positioned within the adapter.

FIG. 45A is a perspective exploded view of an alternative embodiment of threaded adapter, featuring a waterline connector.

FIG. 45B is a front elevation exploded view of the threaded adapter of FIG. 45A.

FIG. 45C is a front elevation exploded view of the threaded adapter of FIG. 45A being installed in a female socket assembly.

FIG. 46A is a perspective view of the connector of FIG. 45A being installed in a female socket assembly.

FIG. 46B is a perspective view of the connector of FIG. 45A positioned within the female socket assembly.

FIG. 46C is a front elevation view of the adapter of FIG. 45A being installed over the connector.

FIG. 46D is a front elevation view of the adapter of FIG. 45A fully installed over the connector and within the female socket assembly.

FIG. 47A is an exploded perspective view of an alternative bottle embodiment showing the upper bottle portion above the lower bottle portion.

FIG. 47B is a perspective view of the alternative bottle embodiment of FIG. 47A showing the upper bottle portion and lower bottle portion connected.

FIG. 48 is a cross section view of the upper bottle portion of the alternative bottle embodiment of FIG. 47B.

FIG. 49A is a front elevation view of the bottle of FIG. 47B being mounted to an alternative threaded adapter.

FIG. 49B is a front elevation view additional steps of the bottle of FIG. 47B being mounted to an alternative threaded adapter.

FIG. 49C is a front elevation view of the bottle of FIG. 47B mounted to an alternative threaded adapter.

FIG. 50A is a perspective view of a treatment assembly being mounted to the upper bottle portion of the bottle of FIG. 47A.

FIG. 50B is a perspective view of additional steps of a treatment assembly being mounted to the upper bottle portion of the bottle of FIG. 47A.

FIG. 50C is a perspective view of a treatment assembly mounted to the upper bottle portion of the bottle of FIG. 47A.

FIG. 51 is a cross section view of the fully engaged female socket assembly, threaded adapter, and bottle embodiments of FIG. 47B.

FIG. 52 is an exploded perspective view of an alternative assembly featuring a threaded adapter, a quick release adapter, an access guard, and a bottle.

FIG. 53 is a front elevation view of the quick release bottle adapter of FIG. 52.

FIG. 54A is a perspective view of a treatment assembly being mounted to the upper bottle portion and access guard assembly of FIG. 52.

FIG. 54B is a perspective view of additional steps of a treatment assembly being mounted to the upper bottle portion and access guard assembly of FIG. 52.

FIG. 54C is a perspective view of a treatment assembly mounted to the upper bottle portion and access guard assembly of FIG. 52.

FIG. 55A is a front elevation view of the bottle, access guard, and adapter assembly of FIG. 52 being mounted to a threaded adapter.

FIG. 55B is a front elevation view additional steps of the bottle, access guard, and adapter assembly of FIG. 52 being mounted to a threaded adapter.

FIG. 55C is a front elevation view of the bottle, access guard, and adapter assembly of FIG. 52 mounted to a threaded adapter.

### DETAILED DESCRIPTION

In the following description, for the purposes of explanation, numerous specific details are set forth in order to provide a thorough understanding of the described embodiments. It will be apparent to one skilled in the art, however, that other embodiments may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Bacteria or other organisms can be present in municipal tap water when initially placed into a dental water supply system. Over time, these organisms reproduce and typically will form a biofilm over system surfaces, including but not limited to the interior surfaces of any bottle, uptake tube, filter, other treatment assembly, water supply line, and other water contacting apparatus. In addition, tap water may include detrimental inorganic compositions or materials, including but not limited to particulate matter and residual chlorine.

For example, a dental water supply system may be shocked periodically by applying a biocidal composition to the water at a sufficient concentration to kill and remove accumulated biofilms. A system may be shocked by adding a strong oxidizer such as a chlorine, bromine, or iodine containing composition to the water. After the shock treatment has completed, the water and shock chemicals in the system are typically removed and the system is refilled. Subsequently, it may be advantageous to provide a maintenance level of anti-microbial compounds or filtration as the system is used to supply water to dental instruments. The embodiments disclosed herein can enhance both periodic “shock treatment” type maintenance processes and daily or continuous use maintenance processes.

### A. Dental Water Supply Bottles

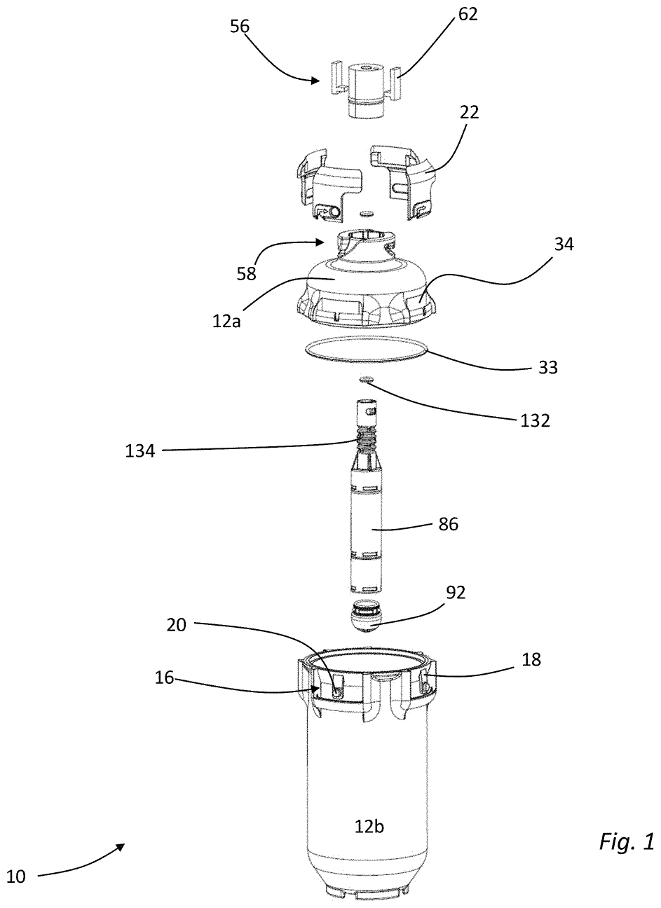

As shown in FIG. 1, certain embodiments disclosed herein are a dental water supply system 10 including a bottle 12. In the embodiment of FIG. 1, the bottle 12 includes two user-separable portions, an upper bottle portion 12a and a lower bottle portion 12b. In normal use, the upper bottle portion 12a and lower bottle portion 12b are mated together at a sealed joint 14 such that the bottle 12 can effectively contain water and pressurized air to be supplied to a dental water supply system 10. Specific attributes of the sealed joint 14 are discussed below.

In some embodiments, the upper bottle portion 12a and lower bottle portion 12b can be mated together or disconnected from each other without the use of tools. For example, as shown in FIGS. 1-5, the lower bottle portion 12b may include one or more connectors 16. The figures illustrate an embodiment with four connectors 16 distributed symmetrically around an upper perimeter of the lower bottle portion 12b, although any number of connectors 16 may be provided in alternative embodiments. Each connector 16 includes a flexible arm 18 and a locking button 20 which function as described below. The flexible arm 18, or the entire connector 16 may be fabricated from an inherently flexible material, such as certain thermoplastics, or a thin strip of metal. Alternatively, the flexible arm 18 may include flexible regions, springs, hinges, or other structures providing flexibility.

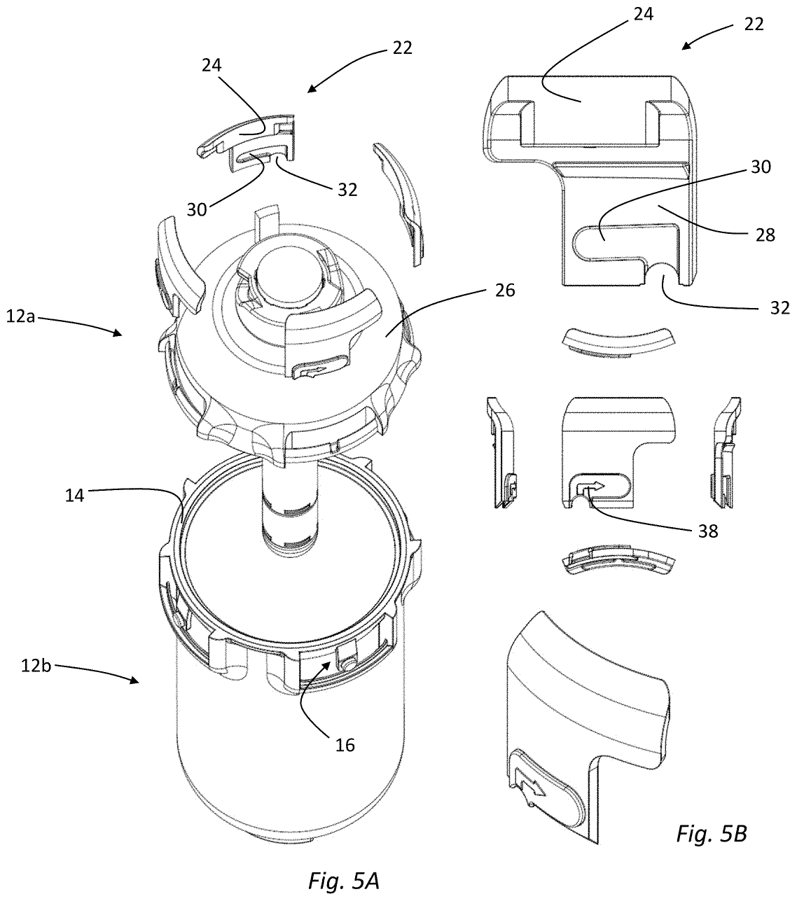

As also shown in FIGS. 1, 2, 4, and 5, the bottle 12 may include a number of separable insert clips 22 typically, but not necessarily corresponding to the number of connectors 16. As best shown in FIG. 5, each insert clip 22 may include an upper surface 24 shaped or formed to conform to an upper shoulder region 26 of the upper bottle portion 12a. In addition, each insert clip 22 may include a lower connection region 28 defining an inward facing connection slot 30. The connections slot 30 terminates in an opening 32 at the bottom of the connection region 28.

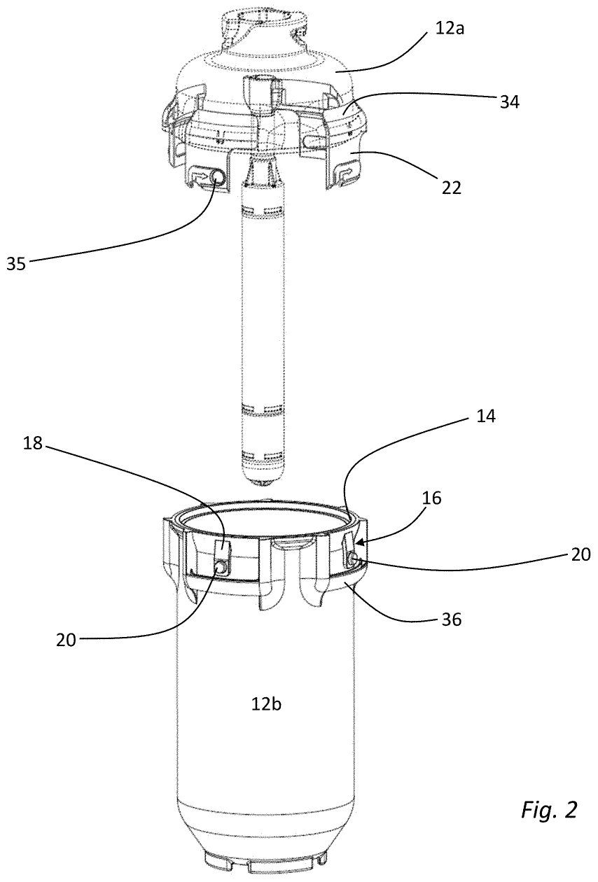

As illustrated in FIGS. 1 and 2, each insert clip 22 may be mounted to the upper bottle portion 12a by placing the connection region 28 of the insert clip 22 through an upper aperture 34 defined by or formed in the upper bottle portion 12a. In the illustrated embodiments, the insert clip 22 and upper bottle portion 12a are physically separate structures operationally connected together by the upper aperture 34 or a functionally similar structure associated with the upper bottle portion 12a. This configuration permits the connection region 28 of an insert clip 22 to pivot outward away from or inward toward the lower bottle portion 12b when the upper bottle portion 12a is connected to (or disconnected from) the lower bottle portion 12b. In alternative embodiments, the insert clip 22 or an analogous structure may be co-formed with the upper bottle portion 12a or permanently mounted to the upper bottle portion 12a. In such an alternative embodiment, the connection region 28 may be flexible or have a flexible portion, hinge, spring, or similar structure allowing the connection region to pivot toward or away from the lower bottle portion 12b.

Thus, the illustrated insert clip structures 22 are separable from the upper bottle portion 12a, rather than being co-molded or otherwise co-formed portions of the upper bottle portion. Separate or separable insert clips may provide manufacturing advantages. In embodiments featuring separate or separable insert clips, the insert clips 22 may be held captive in the upper aperture 34 by appropriately positioned notches, tabs, pins, or other structures which retain the insert clips 22 in the upper aperture 34, while still permitting the pivoting motion described above. Thus, the insert clips 22 may be mounted in the upper aperture 34 as a preliminary step during the initial assembly of an upper bottle portion 12a. Alternatively, the insert clips 22 may be freely removable from the upper bottle portion 12a.

In the illustrated embodiments, the upper bottle portion 12a and the lower bottle portion 12b may be connected by placing the upper bottle portion 12a having insert clips 22 received in upper apertures 34 into proximity with a lower bottle portion 12b. Specifically, the opening 32 of each connection slot 30 defined by each insert clip 22 may be positioned to correspond with a locking button 20 on each connector 16 associated with the lower bottle portion 12b. Then, the bottle portions 12a, 12b may be pressed together while the locking buttons 20 engage with corresponding connection slots 30. The upper bottle portion 12a may then be rotated to capture each locking button 20 in a portion of the connection slot 30 away from the opening 32. The dimensions and configuration of the connectors 16, insert clips 22, and connection slot 30 can be coordinated to assure that the upper bottle portion 12a and lower bottle portion 12b are closely mated when each locking button 20 is captured in a corresponding connection slot 30 away from the opening 32. In certain embodiments, a main O-ring 33, gasket, or similar structure may be provided between or mounted to one bottle portion or the other to assure that the sealed joint 14 is watertight when the upper bottle portion 12a is fully mounted to the lower bottle portion 12b.

Some embodiments may include a hole 35 formed in one or more of the connection slots 30, as shown in FIG. 2. Any hole 35 will typically be positioned away from the opening 32. Thus, the corresponding locking button 20 may engage with the hole 35 when the upper bottle portion 12 a is rotated to capture each locking button 20 and a portion of the connection slot 30 away from the opening 32. Thus, unintentional rotational disengagement of the upper bottle portion 12a and lower bottle portion 12b may be minimized or eliminated unless any locking button 20 is first disengaged with a corresponding hole 35 as detailed below.

Some embodiments may include a lower aperture 36 defined or formed in the lower bottle portion 12b that is configured to capture a bottom portion of the connection region 28 of an insert clip 22 when the upper bottle portion 12a and lower bottle portion 12b are fully mated together. In certain embodiments, a notch, tab, clip, ledge, or other structure formed on an interior surface of the lower aperture 36 may capture a corresponding structure on an insert clip 22 when the insert clip 22 is rotated into a locked position. Thus, lower aperture 36 in an embodiments having a capture structure will serve to prevent undesired motion of the insert clips 22 and limit inadvertent release of any locking button 20 from a corresponding connection slot 30.

The upper bottle portion 12a and lower bottle portion 12b may be separated from each other by substantially reversing the attachment processes. If at least one hole 35 has been provided to engage with the corresponding locking button 20, a user may manually depress the locking button 20 through the hole 35 to disengage these elements. Then, the upper bottle portion 12a and the attached insert clips 22 may be rotated slightly in the direction opposite the capture direction such that that any locking button 20 is positioned in the corresponding connection slot 30 adjacent to the opening 32. If the lower aperture 36 includes structure to capture the insert clip 22 and lock it into place, it may be necessary to depress the insert clip toward the upper bottle portion 12a or otherwise disengage any locking mechanism before the upper bottle portion/insert clip assembly is rotated to release the connectors 16. The insert clip 22 can be depressed toward the upper bottle portion 12a since it can pivot within the upper aperture or is otherwise designed to be flexible. The locking button 20 is similarly free to be depressed inwardly through action of the flexible arm 18. When the locking buttons 20 are positioned adjacent corresponding openings 32, the upper bottle portion 12a and the lower bottle portion 12b may be separated. In some embodiments, an exterior surface of the connection slot 30 or another structure may include an indicia 38, for example the arrow shown in FIG. 5, graphically representing the relative rotational motion of the upper bottle portion 12a during engagement or disengagement processes.

Alternative structures can be provided to engage, disengage, secure, and prevent the unintentional disengagement of the upper bottle portion 12a from the lower bottle portion 12b. For example, the upper bottle portion 12a and lower bottle portion 12b may define corresponding threads providing for a threaded engagement between these portions at the sealed joint 14. Alternatively, a separate rotatable but otherwise captured collar may be provided on one of the bottle portions to engage with threads on the other bottle portion. Alternatively, the upper and lower bottle portions 12a, 12b may be engaged and disengaged using any style of clip, snap, screws, external connectors, and the like certain alternative bottle embodiments are described below.

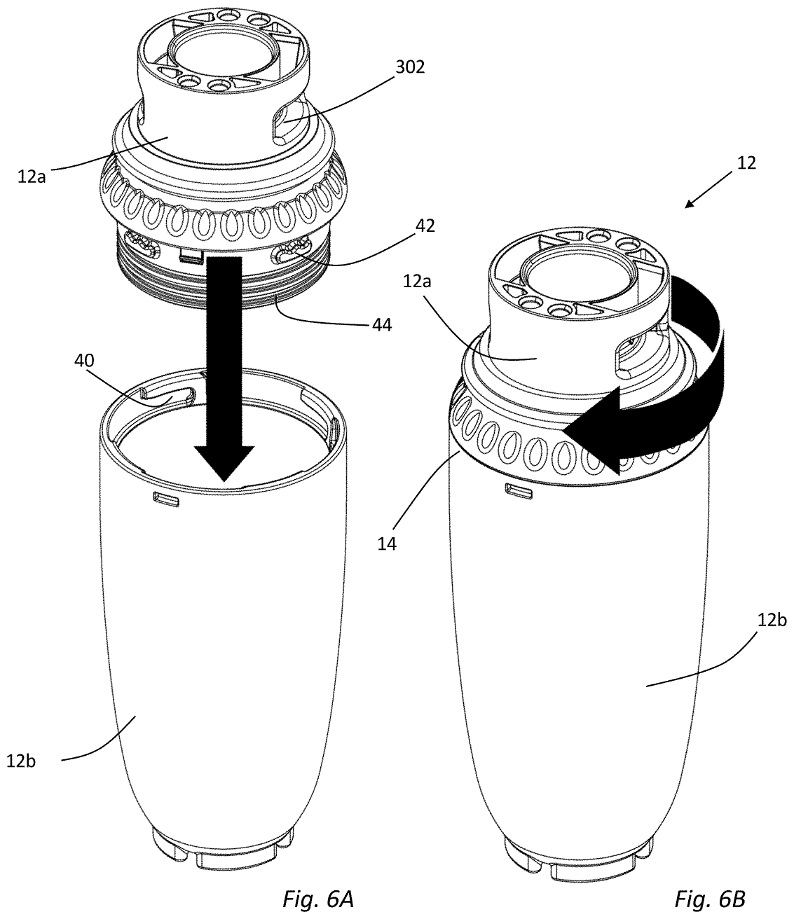

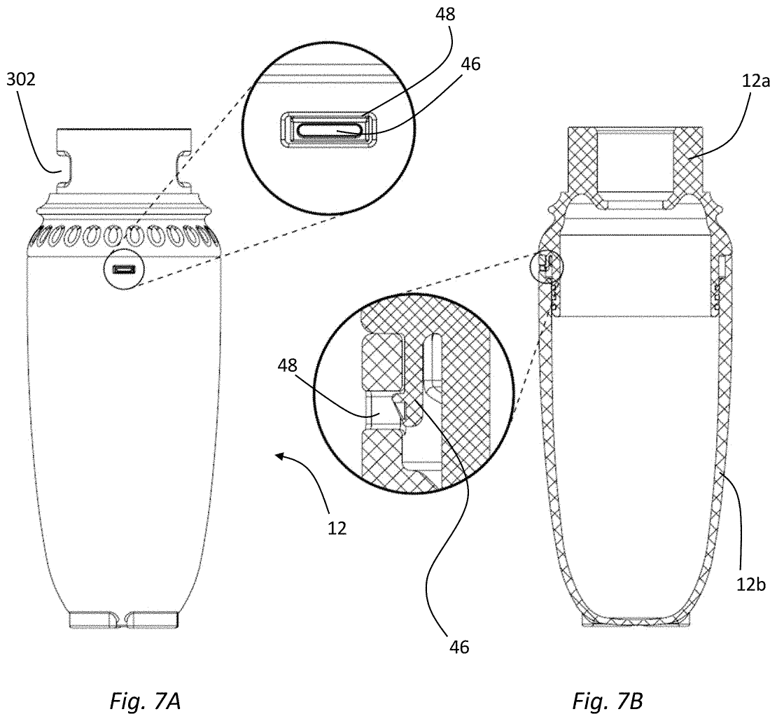

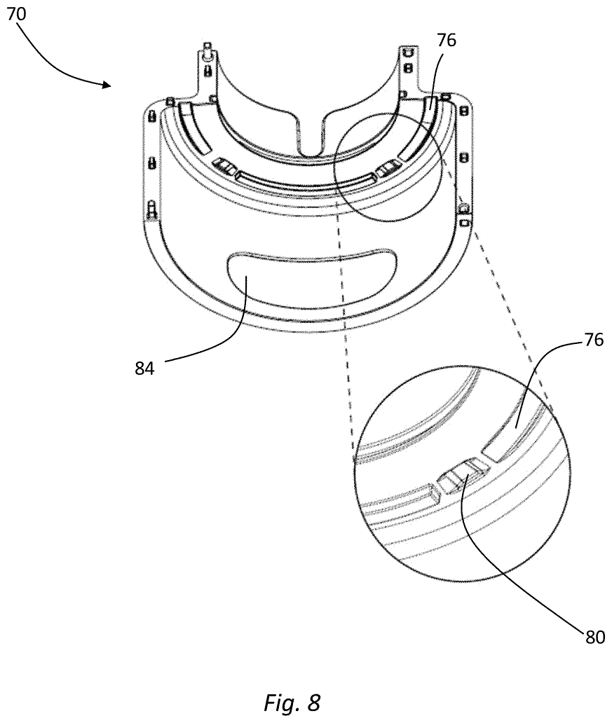

In one alternative bottle 12 embodiment, as shown in FIGS. 6-7 a bottle 12 may include an upper bottle portion 12a and lower bottle portion 12b joined at a sealed joint 14. Specifically, the lower bottle portion 12b may include one or more blind slot structures 40 machined, molded or otherwise formed in a surface, specifically an interior surface of the lower bottle portion 12b. The upper bottle portion 12a may include a number of corresponding and mating engagement studs 42, which can be captured in the corresponding blind slot structures 40 when the upper bottle portion 12a is placed into engagement with the lower bottle portion 12b and rotated as illustrated in FIG. 6B. In the illustrated embodiment, the blind slot structures 40 have a female configuration which captures the male engagement studs 42. In an alternative embodiment, the female structure could be associated with the upper bottle portion 12a, or both structures could have a male, female, or another configuration sufficient to join the upper bottle portion 12a to the lower bottle portion 12b. As also shown in FIG. 6A one or more O-rings 44 or similar compliant structures provide a watertight and pressurized airtight seal at the sealed joint 14.

As described in detail below, the bottle 12 of FIGS. 6-7 uses a separate wide-format adapter for mounting to a dental water system 10, therefore, it is typically unnecessary for dental office staff to separate the bottle portions for filling or routine maintenance as described above. Accordingly, as best shown in FIGS. 7A and 7B, bottle 12 embodiments may include a locking clip 46 or alternative locking mechanism which is engaged with a slot 48 to prevent or limit reverse rotation and disengagement of the upper bottle portion 12a from the lower bottle portion 12b. In the illustrated embodiment, the locking clip 46 and slot 48 are located on the upper bottle portion 12a and the lower bottle portion 12b respectively, but the position of these structures could be reversed. Although the locking clip 46 and slot 48 structures serve to prevent disengagement of the upper bottle portion 12a from the lower bottle portion 12b, it is useful for both routine treatment assembly replacement or maintenance, and non-routine maintenance, part replacement, or other tasks performed by a skilled technician to permit these structures to be disengaged. In the illustrated embodiment, a technician with a flat head screwdriver or similar tool can depress the locking clip 46 out of engagement with the slot 48 to permit rotation of the upper and lower bottle portions out of engagement with each other.

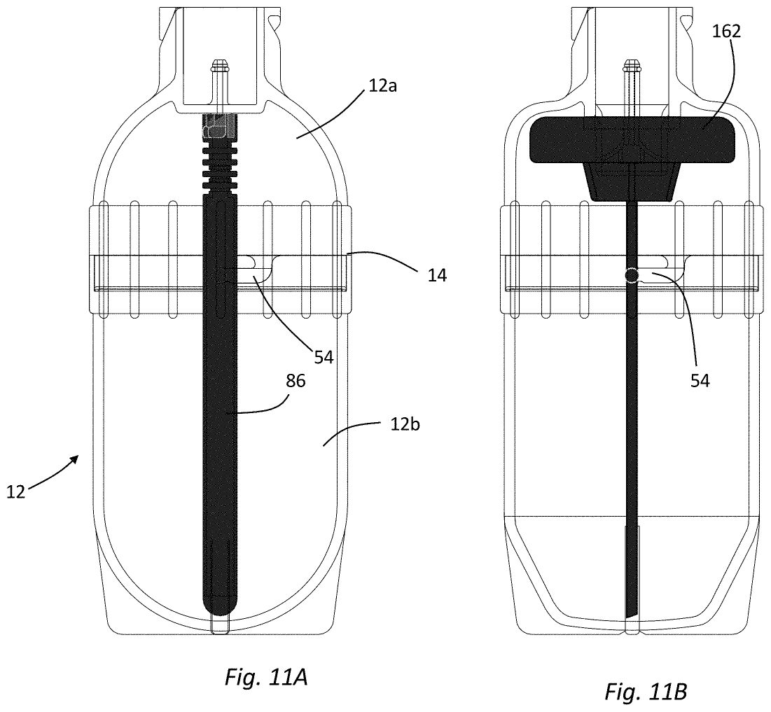

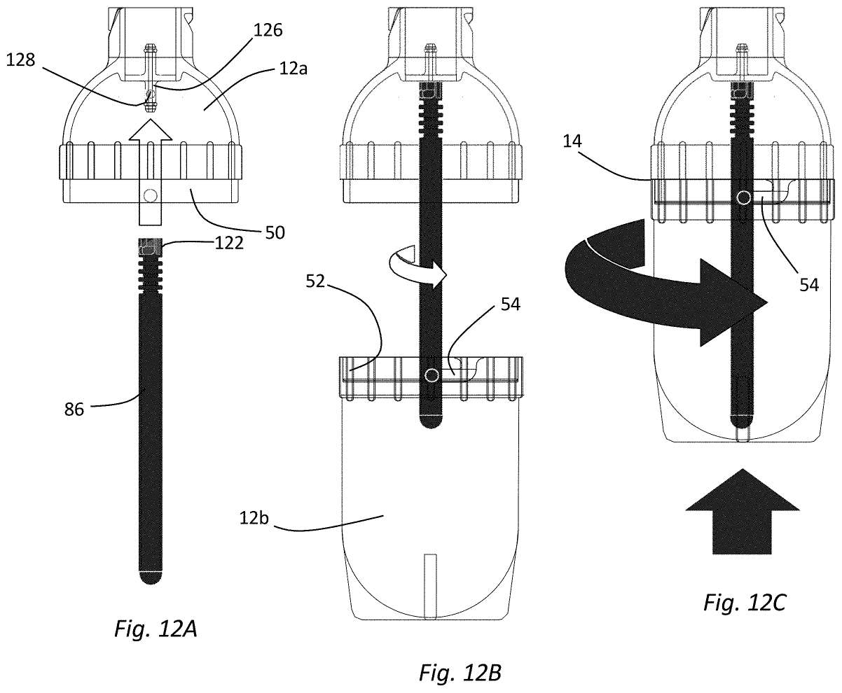

A third embodiment of bottle 12 having upper and lower bottle portions 12a, and 12b, is shown in FIGS. 11 and 12 and. One of the upper or lower bottle portions 12a, 12b may include a flange 50 that is captured in a corresponding groove 52 on the opposing portion. The interface between the flange 50 and groove 52 may support an optional O-ring, gasket, or the like to provide a watertight and airtight sealed joint 14. Inadvertent separation of the flange 50 and groove 52 may be provided by one or more clips 54, buttons, screws, tab and slot combinations, or similar structures.

Returning to FIG. 1, a dental water supply system 10 will typically include a bottle mounting bracket 56. The bottle 12 will typically include structure permitting the bottle 12 to be efficiently attached to or removed from the bottle mounting bracket 56. Alternatively various adapters may be supplied, as disclosed herein, to facilitate the mounting of a bottle 12 to a bottle mounting bracket 56 having any configuration.

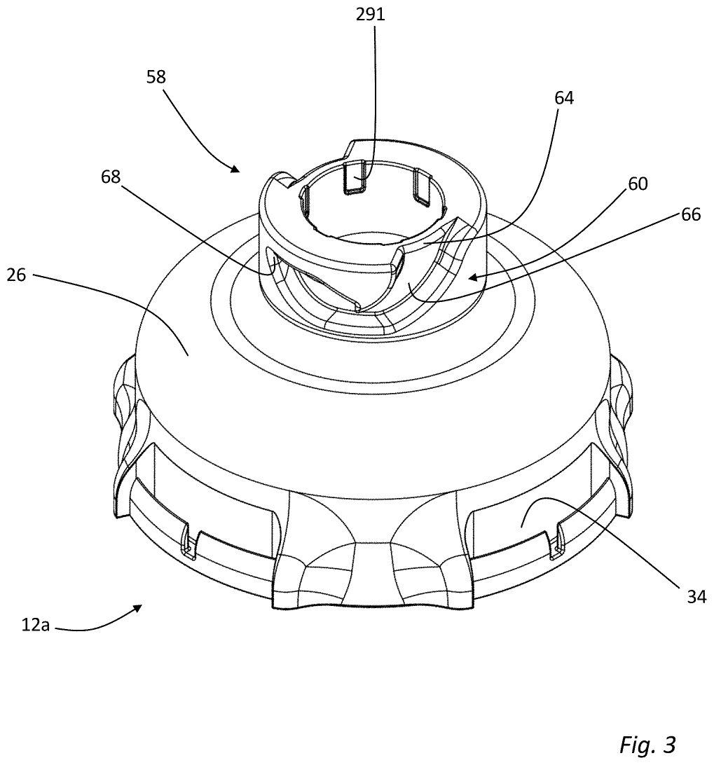

In some bottle embodiments, for example the embodiment of FIG. 1, the upper bottle portion 12a includes a quick release neck 58 configured to engage at the upper end with the bottle mounting bracket 56 without the use of tools. In the illustrated examples, the quick release neck 58 includes one or more twist lock grooves 60 configured to engage with the arms 62 of a bottle mount bracket 56. As best shown in FIG. 3, the illustrated twist lock grooves 60 include one or more upward facing openings 64, a generally curved channel 66 and a seating region 68. Together these structures permit the twist lock grooves 60 to be placed around the bottom portions of the bottle mounting bracket arms 62 as the bottle 12, or upper bottle portion 12a, is rotated into a locked position with the seating region 68 seated against the arms 62 of the bottle mounting bracket 56.

The illustrated quick release neck 58 of FIG. 1 can be co-formed or co-molded with the upper bottle portion 12a. Alternatively, a quick release neck 58 could be a separate structure temporarily or permanently bonded to the upper bottle portion 12a in the neck region.

As noted above, it can be desirable that the interior of a bottle 12 and any associated apparatus located within the bottle 12 be accessible for routine maintenance, treatment assembly replacement, or similar operations. With some disclosed embodiments, the entire bottle assembly, including the upper and lower bottle portions 12a and 12b plus any apparatus contained therein may be removed by simply rotating the quick release neck 58 out of engagement with the bottle mounting bracket 56. The assembled bottle 12 may then be refilled from a conventional tap through an upper opening in the quick release neck 58. If necessary for routine maintenance however, the entire bottle 12 assembly may be taken to a convenient location, for example a back-office workbench for maintenance operations. Access to any internal filters, treatment assemblies, or other structures is provided by separating the upper and lower bottle portions 12a, 12b as described above. It is important to note that both the removal and installation of a bottle 12 from a bottle mounting bracket 56, and the separation or reconnection of the upper and lower bottle portions 12a, 12b may be accomplished in some disclosed embodiments without the use of tools.

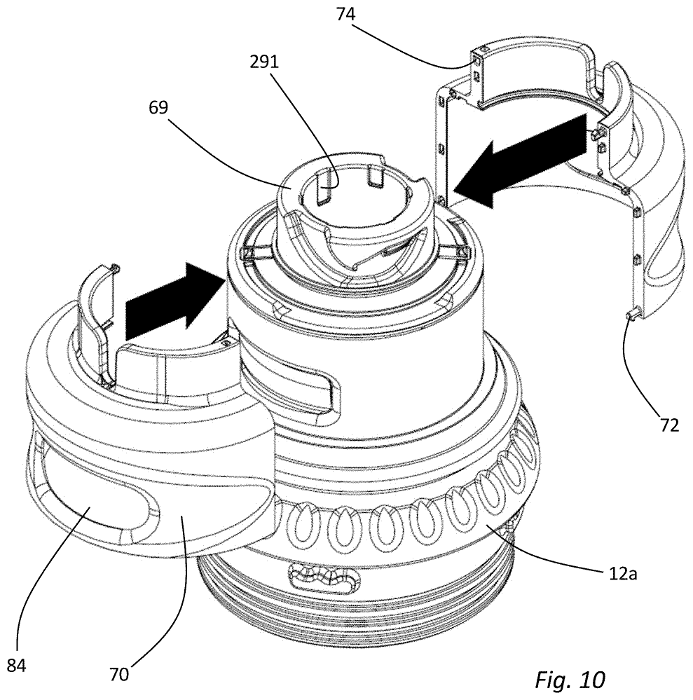

The bottle 12 embodiment of FIGS. 6-7 utilizes a separate quick release bottle adapter 69 which functions much like the co-formed quick release neck 58 described above. In one quick release bottle adapter 69 embodiment, the adapter 69 is attached to the bottle 12, and inadvertent de-attachment is limited by a access guard 70 which can be formed or mounted around a portion of the upper bottle portion 12a is illustrated in FIG. 10. In the illustrated embodiment, the access guard 70 is formed of two portions which are connected using a series of mating hook 72 and corresponding slot 74 assemblies as the access guard 70 is mounted to the upper bottle portion 12a. In an alternative embodiments, the access guard 70 may be a unitary structure, or assembled from any number of parts.

The access guard 70, when mounted, can be rotated with respect to the upper bottle portion 12a. The access guard 70 may include one or more channels 76 which correspond with one or more raised portions 78 associated with the upper bottle portion 12a or associated with the quick release bottle adapter 69. When the access guard 70 is mounted and rotated, each raised portion 78 can ride within the corresponding channel 76, and furthermore each raised portion 78 may become temporarily seated in sockets 80 formed in the access guard 70. The raised portions 78 can be mounted on flexible arms 82. Thus, interaction between one or more channels 76, raised portions 78, sockets, and flexible arms 82 provide for the access guard 70 to be fixed in a first rotated position, with the raised portions 78 seated in corresponding sockets 80, until sufficient force is applied to the access guard 70 to unseat the raised portions and permit rotation to a second position. The above assembly thus provides security against inadvertent rotation but permits the access guard to be easily rotated intentionally.

The rotating access guard 70 is advantageous because the access guard 70 includes one or more windows 84. When the access guard 70 is in the first rotational position, the windows 84 can be positioned to block access to any buttons, levers, or other structures associated with the quick release bottle adapter 69, which are used to disconnect the bottle 12 from the quick release bottle adapter 69 as described below. Similarly, when the access guard is in a second rotational position, the window 84 is positioned to permit access to the structures necessary to disconnect the bottle 12 from quick release water bottle adapter 69.

In use, a bottle 12 may be engaged with an appropriate bottle mounting bracket 56 using whichever one of a quick release neck 58, or quick release bottle adapter 69 is provided with the bottle 12. In either instance, the bottle 12, or the bottle 12 and adapter 69 assembly can be removed from the mounting bracket 56 without the use of tools. Access to the interior of the bottle may be accomplished by separating an upper bottle portion 12a from a lower bottle portion 12b, or through the relatively wide neck of a bottle 12 configured for use with a quick release bottle adapter 69, after the quick release bottle adapter 69 is removed. Other advantages of the bottles 12 and quick release bottle adapters 69 described above are disclosed in detail below.

### B. Dental Water Supply Treatment Assemblies

As noted above, a dental water supply system 10 including any embodiment of bottle 12 described herein can enhance access to internal system elements including but not limited to filters or other treatment assemblies positioned within the bottle 12 during use. FIGS. 1, 2, 4, 11, and 12 illustrate various embodiments of treatment assembly 86 which may be included in a dental water supply system 10. As described in detail below, several of the disclosed treatment assembly embodiments are modular and can be periodically filled and refilled with compositions, chemicals, or materials to accomplish specific filtration, treatment, or maintenance tasks. For example, the disclosed treatment assemblies 86 may house chemicals, filter media, anti-microbial compositions, or other materials useful for the performance of periodic water shock treatments and/or useful for continuous water treatment functions. Some of the treatment assemblies 86 disclosed herein have a relatively thin cross-section permitting the treatment assembly 86 to fit through the neck of a conventional dental water supply bottle. Thus, certain embodiments disclosed herein can be treatment assemblies 86 designed to improve the operation of an existing dental water supply 10. Other treatment assemblies 86 disclosed herein have a cross-section greater than the opening through the neck of a conventional dental water supply bottle. These embodiments may provide certain advantages since the relatively larger volumes within the illustrated treatment assemblies can define longer treatment paths, hold more filtration materials or chemicals, or otherwise enhance device performance. These embodiments can be used with a bottle 12 having separable upper and lower portions 12a and 12b, if the relatively large treatment assembly 86 is to be positioned within the bottle 12 and still be accessible for maintenance or replacement. Another class of treatment assembly 86 disclosed below is positioned outside of the bottle, often, but not exclusively, between a bottle and a bottle mounting bracket 56.

Both shock treatments and continuous dental water supply filtration, treatment and/or maintenance can be provided with any appropriate combination of mechanical and/or chemical filtration elements. Mechanical filtration, including but not limited to microfiltration or nanofiltration, serves to capture suspended particles or microorganisms. Chemical treatment, chemical filtration and/or the use of anti-microbial compounds utilize various compositions to capture undesirable chemicals, to eliminate bacteria or other organisms, and/or to capture organic contaminants. Representative chemical filtration or anti-microbial treatment compositions include but are not limited to activated carbon, iodinated resins, silver, copper, or other metal-containing resins or compositions, deionization resins, and others.

The dental water supply treatment strategies necessary to ultimately provide properly treated water to a dental tool may change over time and can be cyclical. For example, the municipal tap water initially placed into a dental water supply system may have, or may develop over time, an unacceptable level of particulate matter, bacteria and viruses. The municipal tap water may also have a residual level of chlorine or bromine ions from the municipal water treatment processes. Although not inherently harmful, residual chlorine or bromine will quickly diminish the capacity of an iodinated treatment resin to kill bacteria and viruses. Thus, it is sometimes important that various filtration steps be accomplished in a desired order. For example, a treatment assembly 86 may include mechanical microfiltration at an input followed by activated carbon filtration to remove residual chlorine or bromine, followed by mechanical filtration, and an iodinated resin anti-microbial stage. The embodiments of treatment assembly 86 disclosed herein are in many instances modular and can therefore be configured during manufacture or by an end-user to accomplish specific filtration goals or to accomplish specific filtration steps in a desired order.

Various embodiments of treatment assembly 86 are illustrated in the figures. It is important to note that many of these embodiments can be used with any dental water supply system 10 or bottle 12 including the disclosed bottles 12 and other available dental water supply bottles. One class of treatment assembly 86 is substantially tube shaped, and in use is configured to be positioned within a bottle 12 between the bottle mounting bracket 56 and the bottom of the bottle 12. Thus, this class of treatment assembly 86 will typically be positioned in place of a simple uptake tube, straw, or other structure providing for water to flow out of a bottle 12 to various downstream dental tools or appliances. A substantially tube-shaped treatment assembly 86 will include an inlet 88 which in use is positioned toward an interior bottom surface of a bottle 12. A substantially tube-shaped treatment assembly 86 also include an upper outlet which in use is typically connected to outgoing water supply lines at or near the bottle mounting bracket 56. In this configuration, water is typically forced through the treatment assembly 86 by providing pressurized air to the interior of the bottle 12 to displace water and force it through downstream system elements.

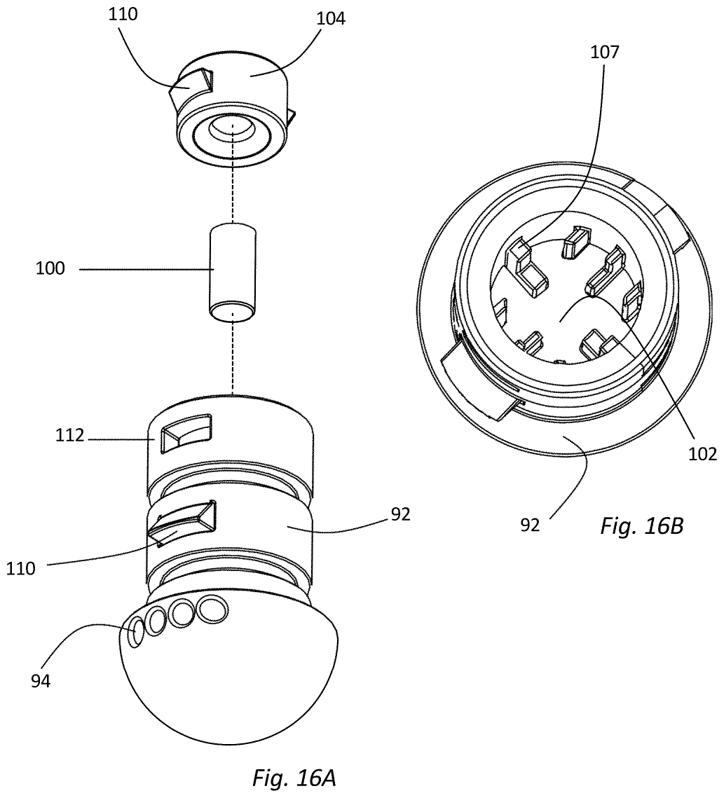

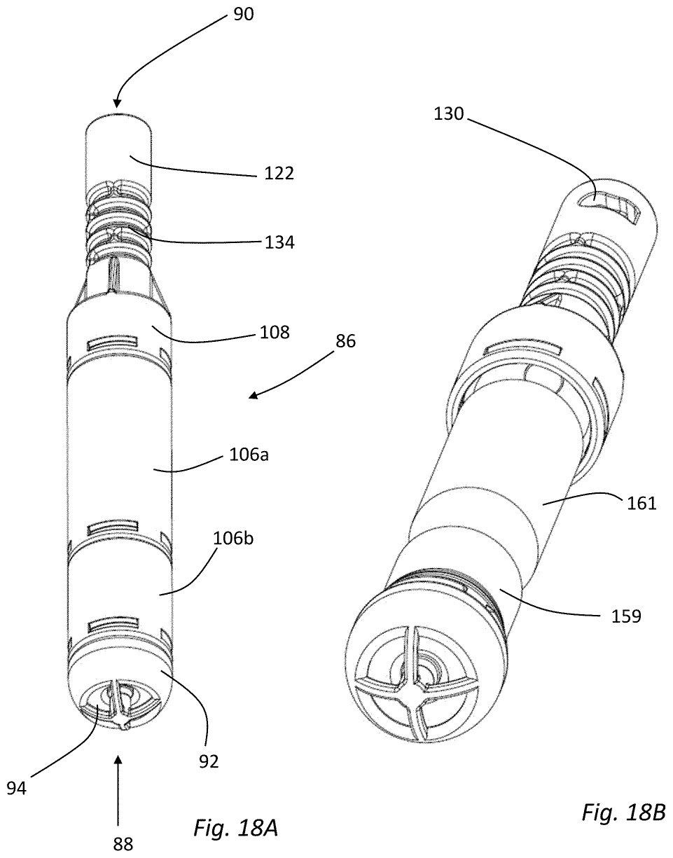

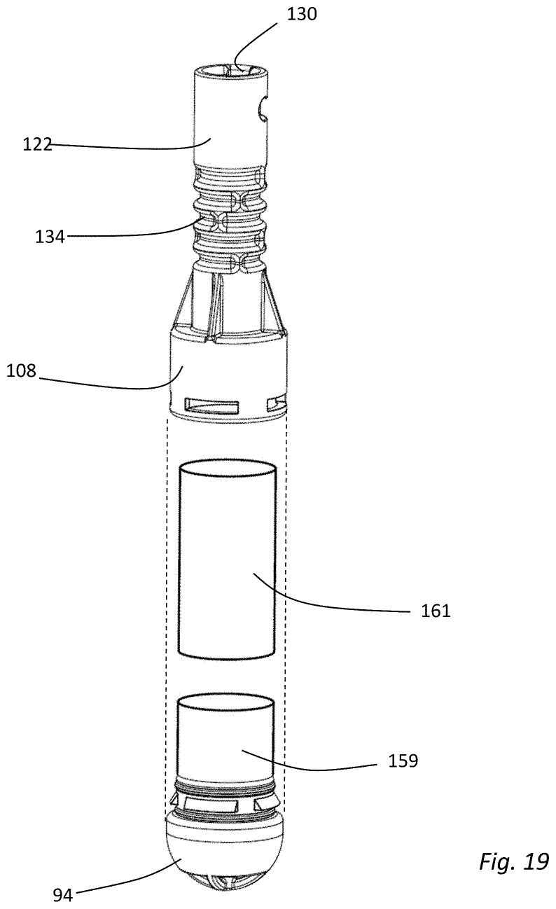

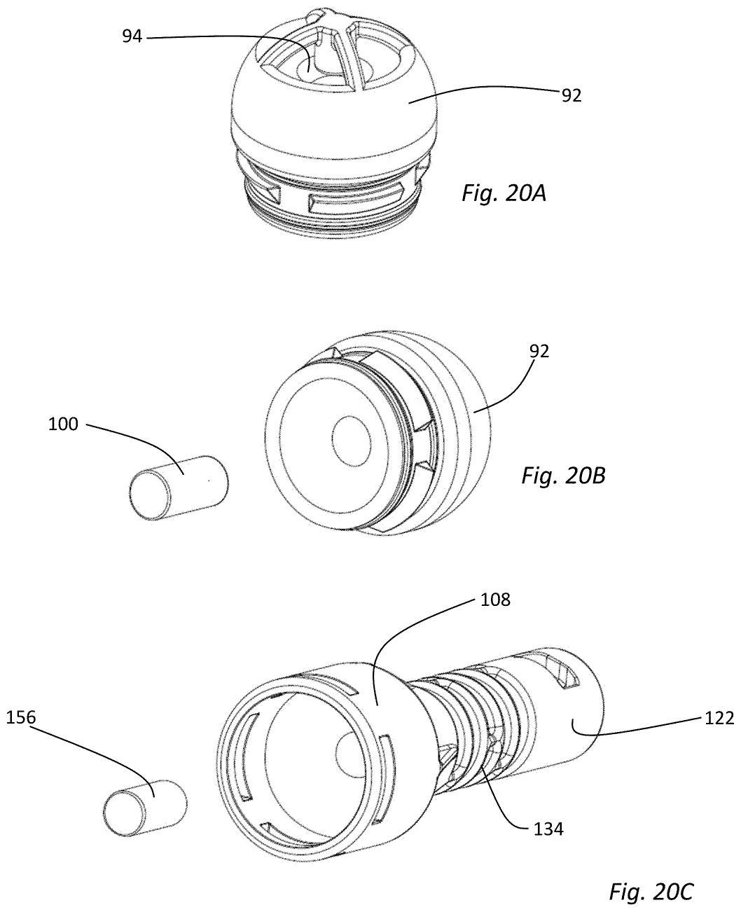

Some embodiments of substantially elongated tube-shaped treatment assembly 86 include a lower end cap 92 corresponding with the inlet 88. The lower end cap 92 will include one or more intake holes 94 opening from an exterior surface of the end cap 92 to an interior channel 96 defined within the treatment assembly 86 between the inlet 88 and outlet 90. The intake holes 94 may be positioned on a side and/or bottom surface of the lower end cap 92. In some embodiments, for example as shown in FIG. 16A, the intake holes 94 are simple holes formed through the end cap 92 to the interior channel 96 adjacent to a concave water catch feature 98. In other embodiments, for example as shown in FIG. 18A, the intake holes 94 are larger openings defined by extensions from the lower end cap 92. In some embodiments, a lower reservoir portion 102 having greater or lesser value may be positioned below the intake holes 94 to capture access water and minimize dripping when the treatment assembly 86 is removed from a system 10.

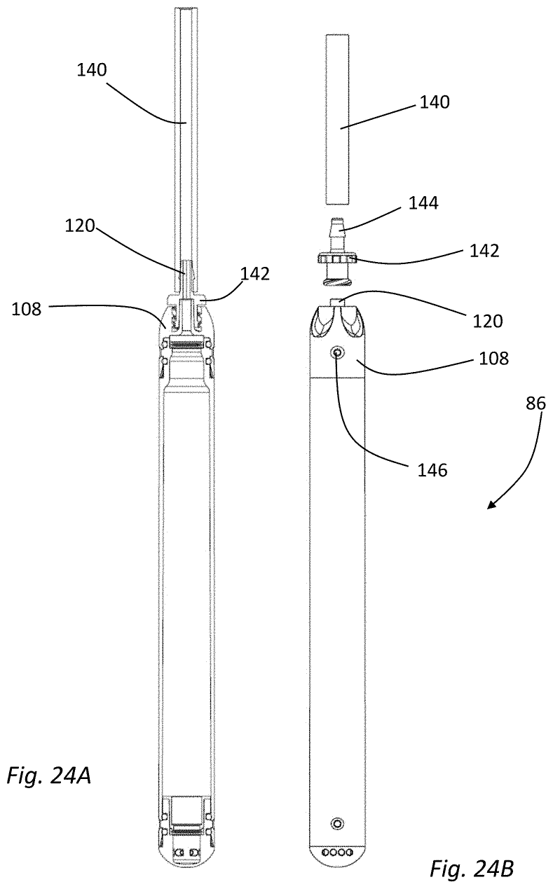

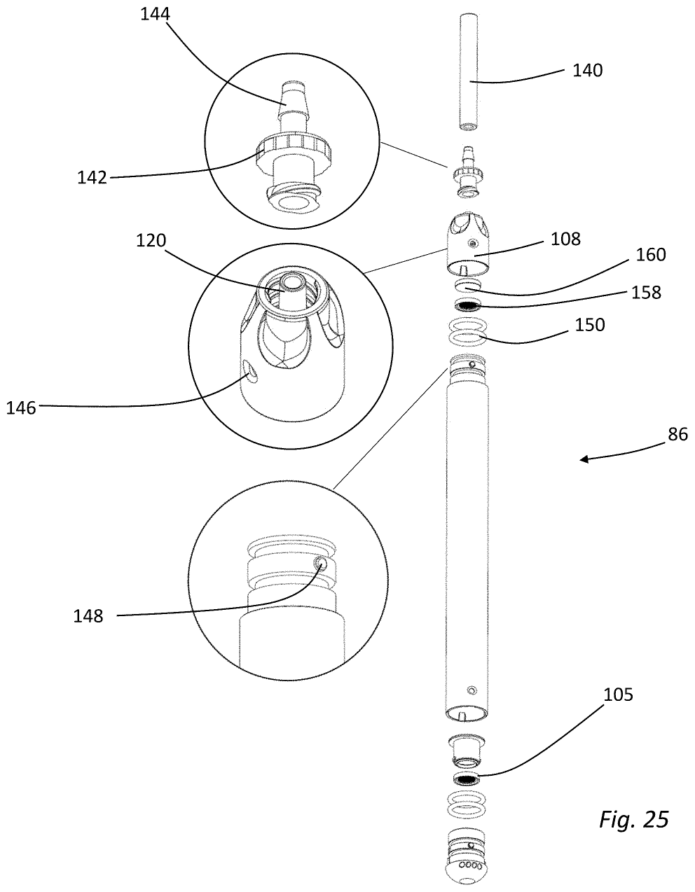

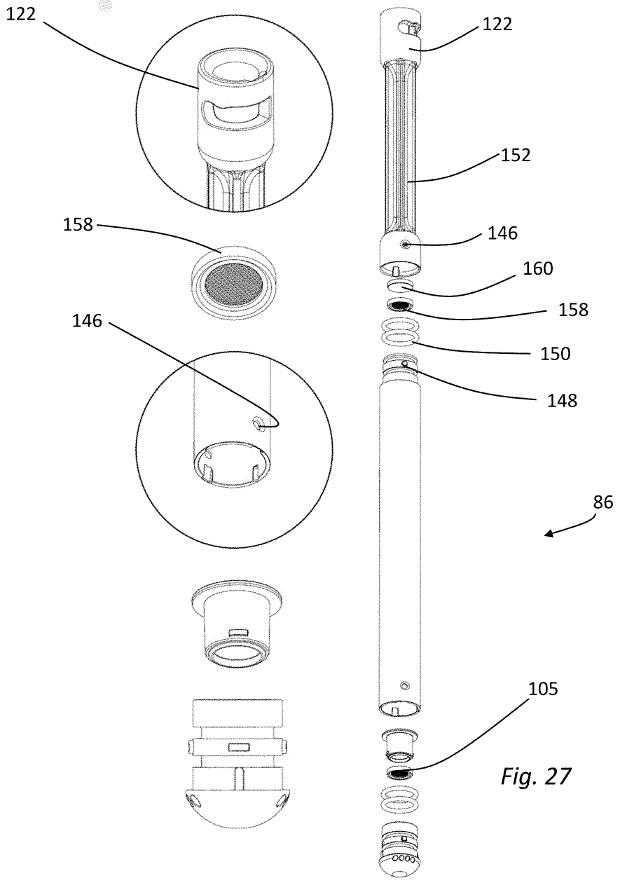

An initial mechanical filter, for example fiber filter 100 may be positioned within the interior channel 96 at or near the lower end cap 92. Fiber filter 100 can serve to filter suspended particulate matter from the water contained within the bottle 12 as it enters the interior channel 96 of a treatment assembly 86 to limit fouling of downstream treatment assembly modules. In some embodiments, fiber filter 100 is held in place by a filter retainer 104 or filter positioning tabs 107. Although the illustrated embodiments include a fiber filter 100, initial mechanical filtration could alternatively be provided by any sort of porous substrate, filter paper, or other substance suitable for providing mechanical filtration. For example, the embodiments of FIGS. 25 and 27 include a coarse gasket and mesh assembly 105 at the inlet 88.

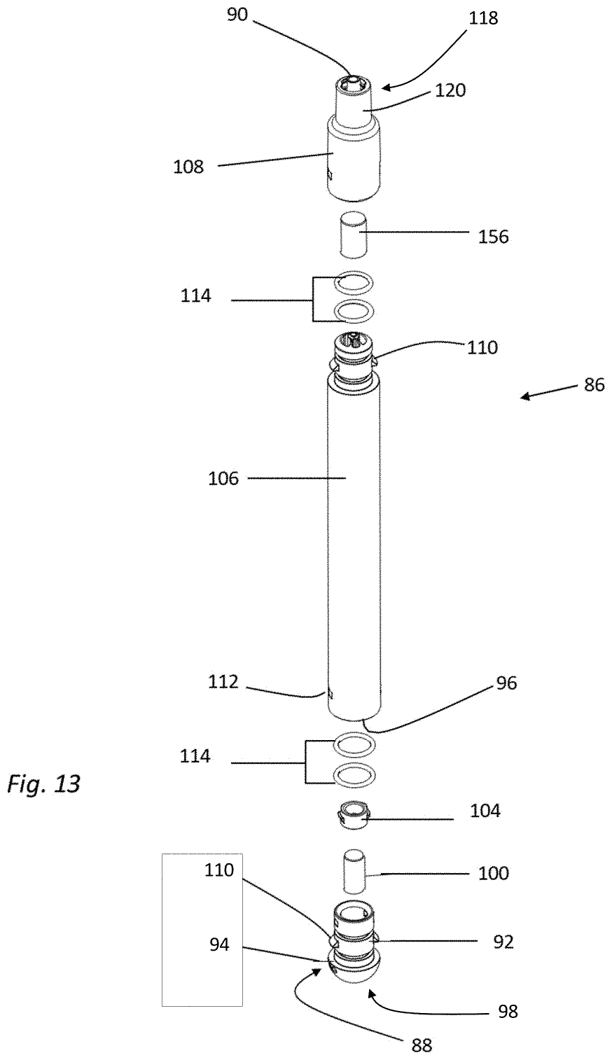

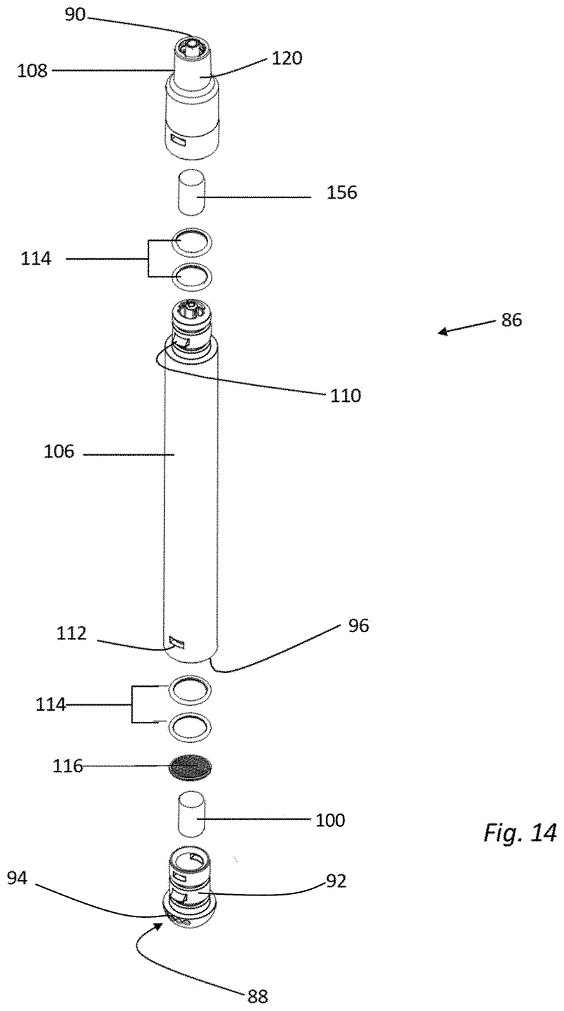

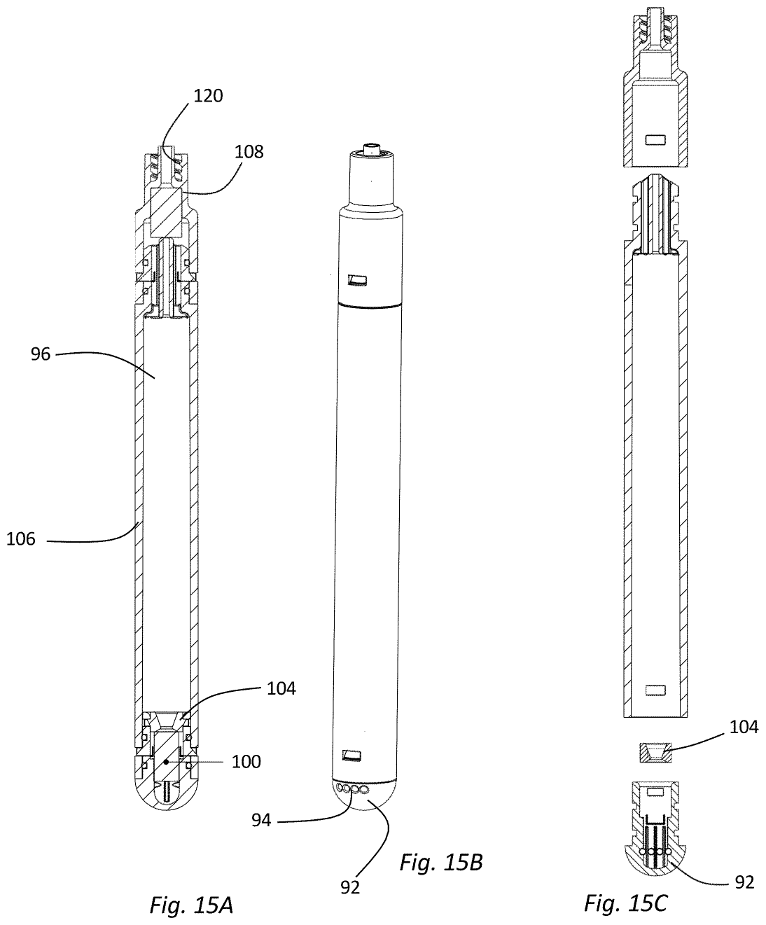

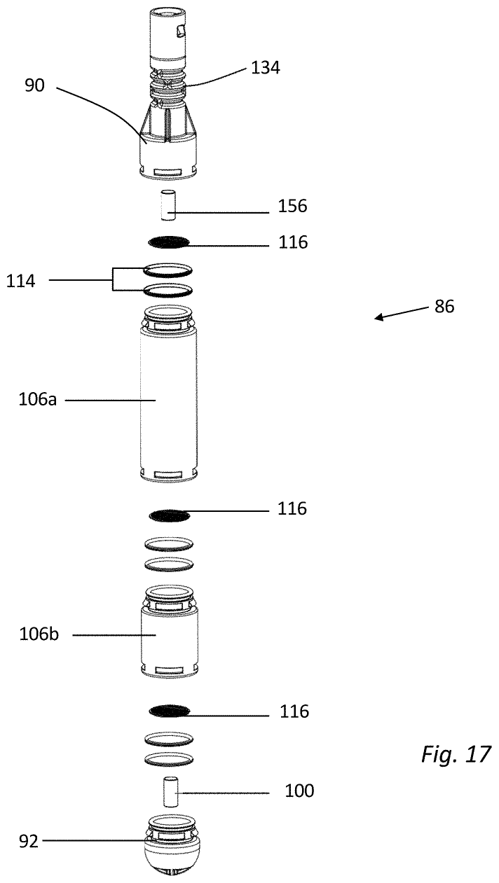

The substantially tube-shaped treatment assemblies 86 can include one or more housing barrels 106 connected to the lower end cap 92 and further defining the interior channel 96. For example, the treatment assembly 86 embodiment of FIG. 13 includes one housing barrel 106, while the treatment assembly 86 embodiment of FIGS. 17 and 18A include two housing barrels 106a and 106b connected in series to each other and extending from the lower end cap 92. Alternative embodiments can include any number of housing barrels 106.

In the illustrated embodiments, each housing barrel 106 is removably connected to the lower end cap 92 and any upstream housing barrel 106 or a top cap 108 using tabs 110 that are configured to mate with corresponding receiver slots 112 formed through the adjacent cap 92, 108, or housing barrel 106. Thus, a treatment assembly 86 having any desired length and any desired number of chambers may be assembled by connecting one lower end cap 92 to a selected number of housing barrels 106 and a top cap 108. All connections may be made with tabs 110 received in corresponding receiver slots 112. Alternatively, any needed connections between the lower end cap 92, housing barrels 106, and a top cap 108 may be formed with threaded connections, permanent bonds, other snap-fit connections, or friction fit connections of any type.

Any non-permanent connection between the caps 92, 108 or housing barrels 106 may be sealed with O-rings 114, gaskets, or similar structures. Any O-ring 114 may be received and secured in an appropriate channel or groove formed in an inner wall of the structure(s) contacting the O-ring 114. In addition, as best shown in FIG. 17, the treatment assembly 86 may include one or more removable strainers 116 captured between adjacent treatment assembly elements. Alternatively, strainers may be co-molded or otherwise formed in selected upper or lower surfaces of a cap 92, 108, or housing barrel 106. In either embodiment, the strainer 116 will traverse the interior channel 96 between adjacent assembly elements. The strainer will have holes, a mesh grid, or other openings positioned across the interior channel 96 which are sized to secure and stabilize any filtration material or composition contained within the interior channel while allowing water to freely pass.

The top cap 108 is positioned generally at the treatment assembly outlet 90 and includes an outlet fitting 118 providing for the treatment assembly 86 to be connected to downstream apparatus, including but not limited to a suitable connector extending from a lower surface of the upper bottle portion 12a, or a lower surface of the bottle mounting bracket 56. Virtually any type of outlet fitting 118 may be incorporated into the treatment assembly 86. For example, as shown in FIG. 13, the top cap 108 may include a threaded male or female Leur lock fitting 120 or an unthreaded male or female Leur slip fitting (not shown). Either type of Leur fitting is configured to engage with and seal with an upstream fitting extending from a downward facing surface of the upper bottle portion 12, a downward facing surface of an adapter, for example the quick release bottle adapter 69, a downward facing surface of a bottle mounting bracket 56, as or other structure.

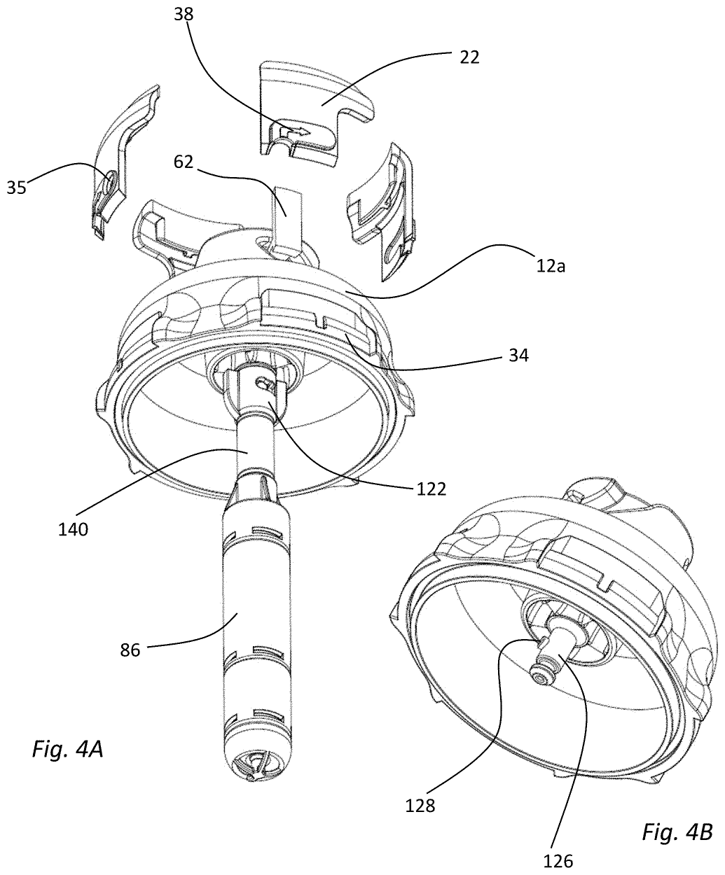

Alternatively, as shown in FIG. 17 the top cap 108 may include a twist lock fitting 122 sized to engage with a generally cylindrical adapter 126 having an engagement stud 128 extending out from the adapter 126. The twist lock fitting 122 of these embodiments may include an engagement channel 130 which opens at the top edge of the generally cylindrical fitting. The illustrated twist lock fitting 122 includes opposing vertical edges 124, to aid in the user's ability to grip and twist the fitting. Other embodiments may include a knurled surface, other protrusions or indentations or other grip enhancing structures. As shown in FIG. 4, the treatment assembly 86 may be engaged with the adapter 126 by sliding the twist lock fitting 122 over the cylindrical adapter such that the engagement stud 128 is received in the engagement channel 130. Then, the twist lock fitting 122 may be twisted or rotated slightly to lock the treatment assembly 86 into place. As shown in FIG. 1, the adapter 126 may include an adapter O-ring 132 in an appropriate groove formed in the adapter 126 to provide a watertight seal with the twist lock fitting 122.

Alternative embodiments of fitting 118 may include alternative connection structures. Alternative connection structures include, but are not limited to threaded connections, press fit connections, hose barb and tubing connections, various sorts of quick-release connections and the like.

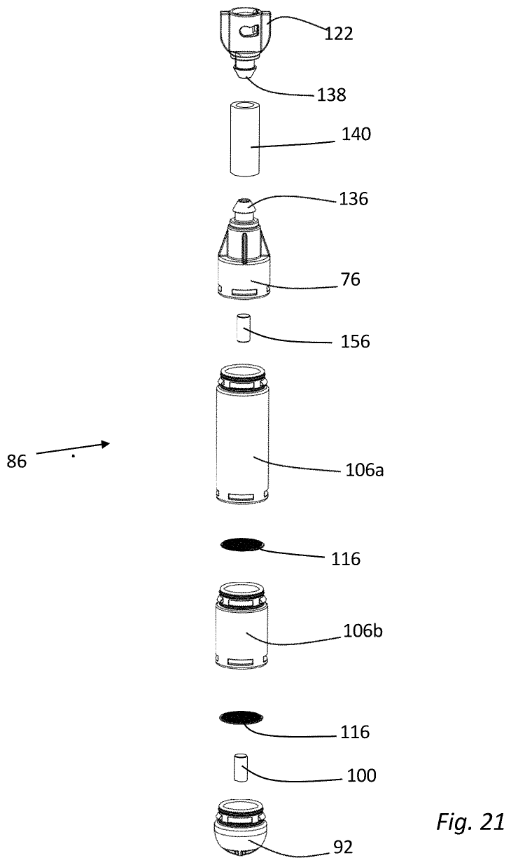

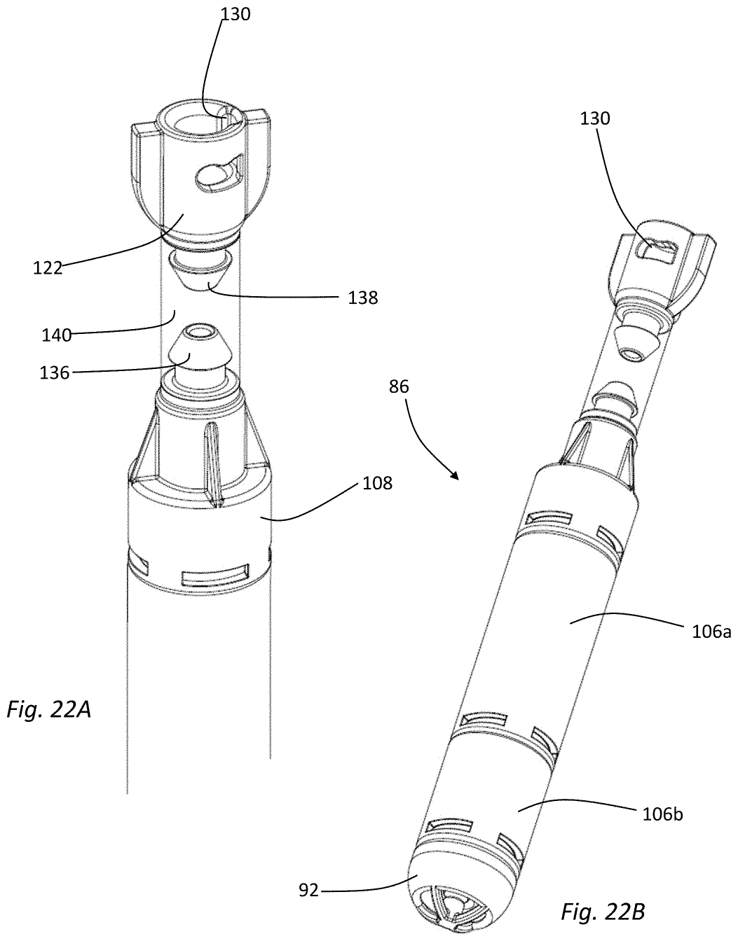

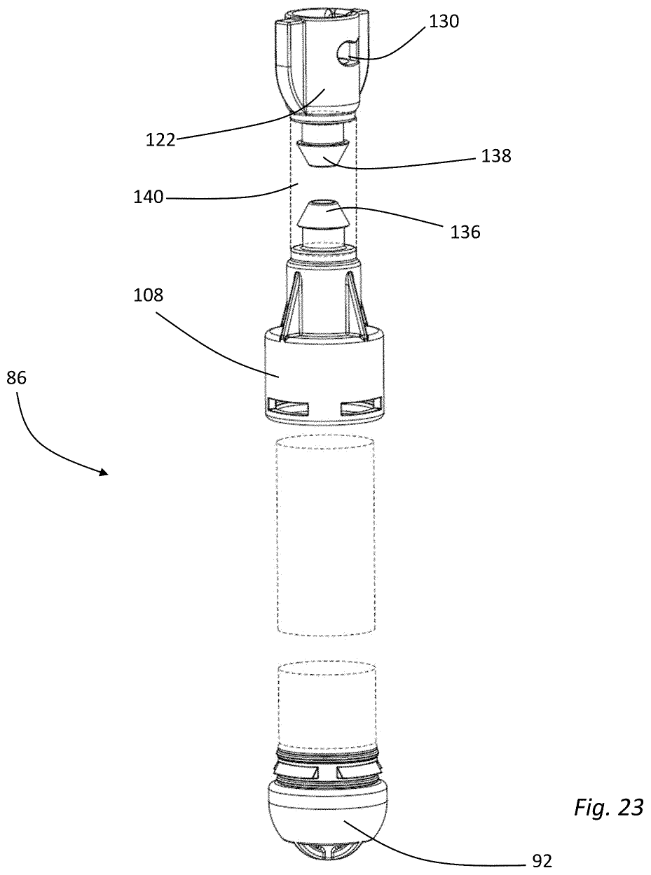

In certain embodiments, it is desirable to have a flexible connection between the fitting 118 and the corresponding downstream structure. For example, as shown in FIGS. 1 and 17, the top cap 108 may include a flexible, possibly corrugated, region 134 between the fitting 118 and lower portions of the top cap 108. Alternatively, as shown in FIGS. 21-23 the fitting 118 at the upper end of the top cap 108 may include a lower hose barb 187 which is connected to an upper hose barb 138 on a separate twist lock fitting 122 with a length of flexible tubing 140. The flexible tubing 140 provides a flexible region 134 and can be cut to length so that a treatment assembly 86 can be positioned at or near the interior bottom surface of a bottle 12 of any height.

The embodiments of FIGS. 24-27 illustrate some nonexclusive alternative structures which may be used to implement an extended length treatment assembly 86, or a treatment assembly 86 having adjustable length. Specifically, the embodiment of FIG. 24A, 24B, and 25 includes a top cap 108 having a male Luer connection 120 at the upper side. This male Luer connection 120 could be attached directly to the underside of a corresponding female structure associated with a bottle 12, adapter 69, bottle mounting bracket 56, or other structure. Alternatively, if the size of the bottle suggests a longer treatment assembly 86, the male Luer connection 120 may be connected to an optional adapter 142, with a female Luer connection at the lower end, and a hose barb 144 at the upper end. The hose barb 144 may be connected to a section of flexible tubing 140 cut to any desired length by a user.

As shown in FIG. 25 the top cap 108 of the FIG. 24 embodiment can be press fit onto an appropriate housing barrel 106, such that a hole 146 or other indentation in the top cap 108 engages with a mounting stud 148 to secure the top cap 108. In such an embodiment a watertight seal between the top cap 108 and the housing barrel 106 can be provided by one or more O-rings 150.

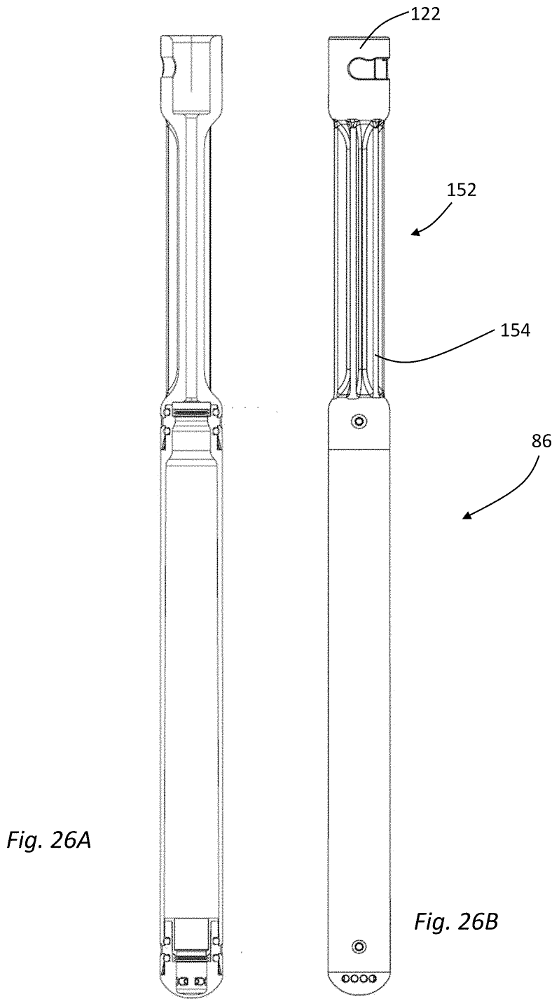

The embodiment of FIGS. 26 and 27 includes a twist lock extension 152 which attaches to a housing barrel 106 using structures as described above with respect to FIGS. 24 and 25. The twist lock extension 152 also includes a twist lock fitting 122, opposite the connection to the housing barrel 106 such as described above. The twist lock fitting 122 may be used to connect the treatment assembly 86 to an appropriate structure associated with an upper bottle portion 12b, adapter 69, or associated with a bottle mounting bracket 56. The twist lock extension 152 includes molded ribs 154 which provides rigidity and an easy surface for a user to grasp while disconnecting the treatment assembly 86 by rotating the twist lock fitting 122.

As noted above, the inlet 60 to the interior channel 68 of a treatment assembly 86 may include a fiber filter 100. Similarly, the top cap 108 may include a secondary fiber filter 156 received within the interior channel 68 at or near the outlet 90. Any number of ancillary mechanical filters may be included within the interior channel 68 of a treatment assembly 86 to accomplish specific filtration goals and to limit the fouling of downstream filter components. For example, the treatment assemblies 86 of FIGS. 24-27 include an upper gasket and mesh assembly 158 providing course mechanical filtration followed by a sintered plastic strainer 160 providing fine mechanical filtration.

Typically, the interior channel 68 within each housing barrel 106 will contain one or more filtering, anti-microbial, or other water treatment compositions or materials. For example, a lower housing barrel 106b may include granular activated carbon (GAC), a carbon block 159, charcoal, or another carbon-based filter element. Carbon-based filter elements are known to effectively remove organic compounds, and various inorganic ions, including but not limited to chlorine or bromine ions which can be present in tap water from a municipal water treatment processes. As noted above, free ions such as chlorine or bromine and more complex halogen-based compositions can compromise the effectiveness certain downstream treatment compositions, including but not limited to iodinated resins.

Similarly, an upper housing barrel 106a may include an anti-microbial or water treatment composition such as an iodinated resin, an iodinated block 161, deionization resins, a silver, copper or other metal containing composition, or other materials. Iodinated resins, silver copper or other metal compositions, and similar compositions serve to kill and filter bacteria, certain viruses, or other organisms which may be present in the municipal water supply, or which may grow within a bottle over time. It is important to note that the treatment assemblies 86 described herein are not limited to any specific filtration or anti-microbial compositions or materials. The treatment assemblies 86 also are not limited to any specific order of different filtration compositions or materials. The modular nature of the illustrated treatment assemblies 86 permit any suitable filtration or anti-microbial material to be used, in any desired order. In addition, the modular treatment assemblies 86 may be refilled by a supplier, or on-site with any desired filtration or anti-microbial composition or material in a manufacturing step, or by an end-user.

The treatment assemblies 86 can be used to facilitate either shock treatment of a system, continuous use filtration and maintenance, or periodic filtration and maintenance of the water in a system. For example, a housing barrel 106 of a treatment assembly 86 may be supplied with a shock chemical to perform a shock treatment. Subsequently, the housing barrel 106 of the treatment assembly may be re-filled or replaced with a housing barrel having a long-term maintenance chemical or anti-microbial compositions or another filtration composition contained therein.

The generally elongated cylindrical treatment assemblies 86 described above can have a thin cross-section permitting them to fit through the opening in the neck of a dental water supply bottle 12. Alternatively, a generally cylindrical treatment assembly 86 may have a wider cross-section, as shown for example in FIG. 2, suitable for use with a bottle 12 having separable upper and lower portions 12a and 12b. A bottle 12 with separable portions 12a, 12b also permits the use of an internal puck treatment assembly 162 as shown in FIG. 11B. A puck treatment assembly 162 may be advantageous since it can potentially house a longer, optionally coiled, interior channel 68 defining a longer filtration and/or treatment path and housing more filtration materials or treatment chemicals than would fit in a generally cylindrical treatment assembly 86. As shown in FIG. 11B, an internal puck treatment assembly 162 includes a housing defining a diameter which is less than the internal diameter of the main volume of a bottle 12, but greater than the restricted diameter of a bottle neck. Thus, an internal puck treatment assembly 162 is typically only accessible for maintenance or replacement if the bottle 12 includes separable upper and lower bottle portions 12a, 12b.

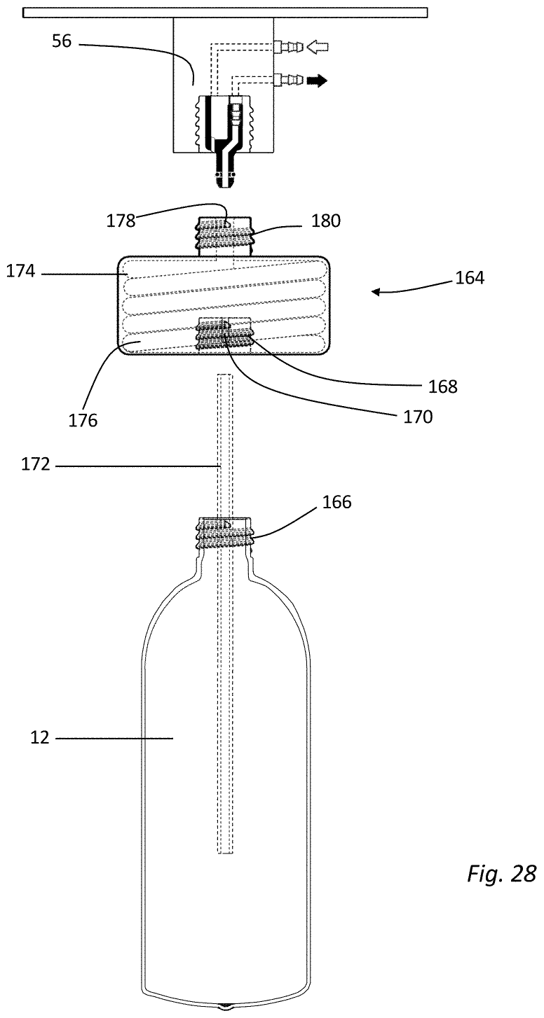

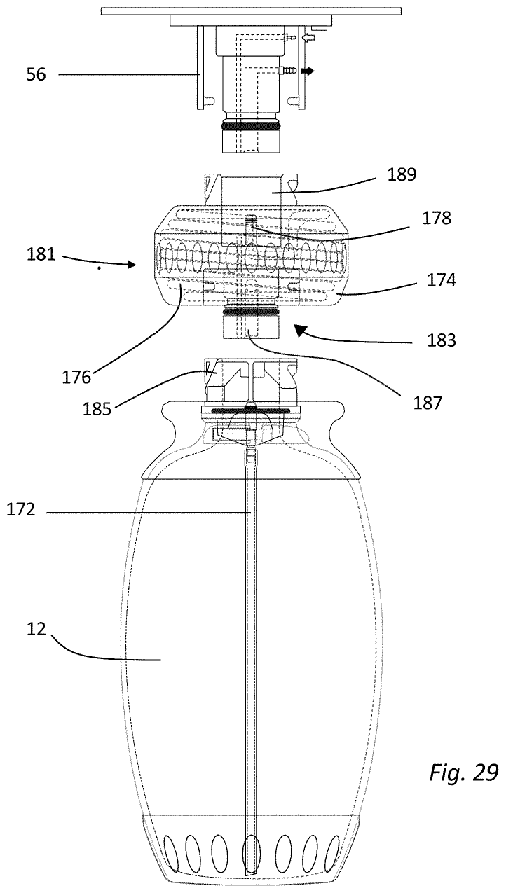

An alternative embodiment illustrated in FIGS. 28 and 29 includes an external puck treatment assembly 164. The embodiment illustrated in FIG. 28 is designed to enhance an existing system where the bottle 12 has a conventional threaded neck 166 configured to engage with a corresponding threaded bottle mounting bracket 56. As initially installed, such a configuration commonly includes a simple take-up straw or hose extending from a hose barb associated with the mounting bracket 56 into the bottle 12 through which water is forced when pressurized air is applied to the interior of the bottle 12. Thus, this configuration is difficult to use with any but the narrowest of add-on filtration elements.

The external puck treatment assembly 164 has a female threaded socket 168 formed in the bottle-facing side of the assembly housing which is configured to receive the threaded neck 166 of a suitable bottle 12. The female threaded socket 168 also includes a lower hose barb 170 sized to receive the existing or a replacement take up straw 172. The lower hose barb 170 is hollow and defines the inlet to an internal filtration compartment 174. In the illustrated embodiment, the internal filtration compartment houses a coiled interior channel 176 leading to an upper hose barb 178. Alternative embodiments may include other internal configurations, including but not limited to multiple chambers in series, multiple chambers in parallel, or any combination or arrangement of chambers, channels, fluid pathways and the like. The upper hose barb 178 can be connected to downstream components including but not limited to a supply tube extending through the bottle mounting bracket 56. The external puck treatment assembly housing further defines a male threaded extension 180 extending upward and typically surrounding the upper hose barb 178. In use, the male threaded extension can be threaded into a female socket in the bottle mounting bracket 56 originally configured to receive the threaded neck 166 of a bottle 12. Thus, an external puck treatment assembly 164 may be installed between an existing bottle 12 and bottle mounting bracket 56 to provide water treatment to an otherwise unfiltered or under filtered system.

An alternative external puck treatment assembly 181 is illustrated in FIG. 29. The embodiment illustrated in FIG. 29 is designed to enhance an existing system where the bottle 12 uses a quick-release twist lock engagement, such as described above. The external puck treatment assembly 181 includes a lower engagement socket 183 in the bottle-facing side of the assembly housing which is configured to receive the quick-release neck 185 of a suitable bottle 12. The lower engagement socket 183 also includes a lower hose barb 187 sized to receive the existing or a new take up straw 172. The lower hose barb 136 is hollow and defines the inlet to an internal filtration compartment 174 of the treatment assembly 181. As noted above, the internal filtration compartment 174 can house a coiled interior channel 176 leading to an upper hose barb 178. Alternative embodiments may include other internal configurations, including but not limited to multiple chambers in series, multiple chambers in parallel, or any combination or arrangement of chambers, channels, fluid pathways and the like.

The upper hose barb 178 can be connected to downstream components including but not limited to a supply tube extending through the bottle mounting bracket 56. The external puck treatment assembly housing further defines an upward facing quick release assembly 189, extending upward and typically surrounding the upper hose barb 178. In use, the upward facing quick release assembly 189 may be engaged in the bottle mounting bracket 56 originally configured to receive the quick release neck 185 of a bottle 12. Thus, an external puck treatment assembly 181 may be installed between an existing quick-release bottle 12 and bottle mounting bracket 56 to provide water treatment to an otherwise unfiltered or under filtered system. Alternative embodiments of external puck treatment assemblies may include any sort of different engagement structure corresponding to the engagement structure between an existing bottle mounting bracket 56 and bottle 12.

In any puck treatment assembly embodiment 162, 164 the main compartment may define multiple filtration or treatment chambers or multiple segments of any interior channel. The chambers or segments defined within a treatment channel may be provided with filtration, or anti-microbial materials, and other treatment compositions generally as described above. The internal treatment components within a puck treatment assembly embodiment 162, 164 may be serviceable or refillable, in particular if the puck housing can be opened. Alternatively, the entire puck 162, 164 and its contents may be disposable.

### C. Dental Water Supply Adapters

1. Adapters for Quick Release Mounting Brackets

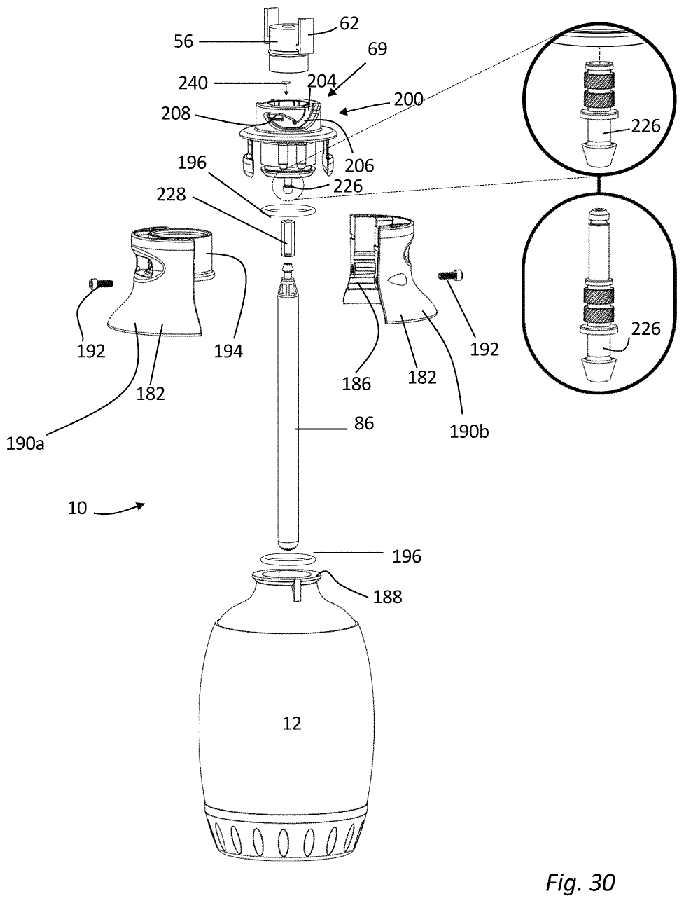

Certain embodiments disclosed herein are configured to enhance the use of an existing bottle 12 and existing bottle mounting bracket 56. For example, as shown in FIG. 30, certain embodiments include a pre-existing dental water supply bottle 12 enhanced as described herein to be more effectively attached to and removed from an existing bottle mounting bracket 56.

Disclosed embodiments designed to enhance the use of an existing bottle 12 and bottle mounting bracket 56 may include a collar 182 configured to attach to the neck of the existing bottle 12. As shown in FIG. 30, the collar 182 may be a two-part structure having a lower apron 184 shaped to conform to the upper shoulders of an existing bottle 12. The collar 182 may include one or more interior grooves 186, ledges, bevels, or similar structures or surfaces configured to engage with or closely mate to corresponding structure present in the neck region of the existing bottle 12. For example, the collar 182 may include interior grooves 186 configured to mate with a flange 188 on the existing bottle 12.

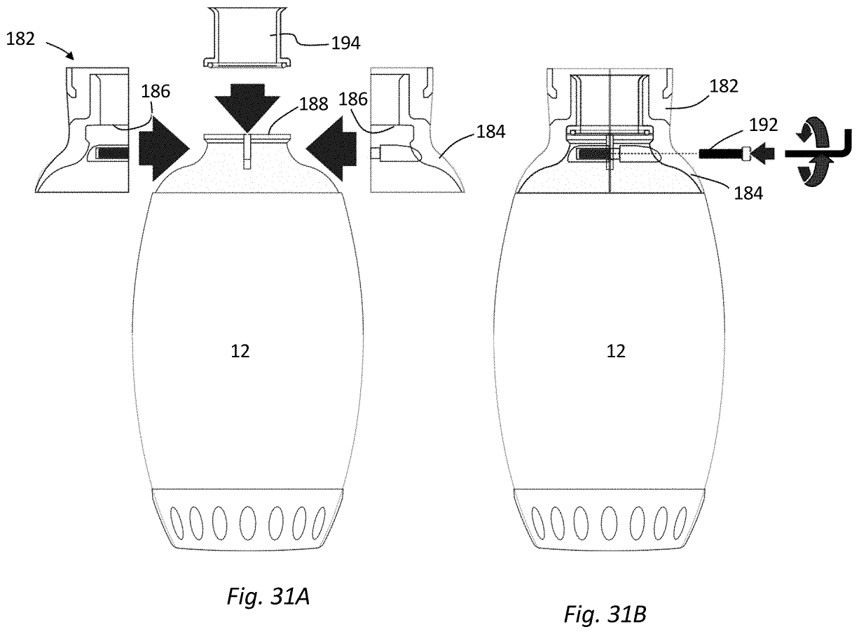

As shown in FIGS. 30 and 31, one nonlimiting embodiment of a collar 182 includes left and right collar halves 190a and 190b that can be clamped to the neck region of an existing bottle 12 using one or more assembly screws 192. Once attached to a bottle 12, it is typically not necessary to remove the collar 182 for any maintenance task, unless it becomes necessary to replace the bottle 12 entirely. In the illustrated embodiment, the left and right collar halves 190a and 190b interface with both the flange 188 and a separate central column portion 194 of the collar 182. In alternative embodiments, the central column structure 194 is co-formed with or permanently bonded to the collar 182. Although the FIGS. 30 and 31 embodiments show a collar 182 having two halves 190a and 190b and a separate central column 194, alternative embodiments may be implemented as a unitary structure, or formed in any number of subcomponents that are temporarily or permanently bonded together to engage the neck region of a bottle 12.

The interface between the central column 194 or a similar structure on the collar 182 with the flange 188 or other upper surface of a bottle 12 may be sealed with a replaceable bottle O-ring 196, a gasket, or a similar structure. The replaceable bottle O-ring 196 provides a watertight seal between the bottle 12 and adjacent structures and prevents contamination of any water in the bottle 12 by outside materials.

The use of an existing bottle 12 and existing bottle mounting bracket 56 may be further enhanced by providing a quick release adapter 69 configured to engage at the upper end with the existing bottle mounting bracket 56 and to engage at the opposite end with the collar 182 attached to the bottle 12. For example, the embodiment of quick release adapter 69 shown in FIG. 30 includes one or more twist lock grooves 200 configured to engage with the arms 62 of an existing bottle mount bracket 56. The illustrated twist lock grooves 200 include one or more upward facing openings 204, a generally curved channel 206 and a seating region 208. Together these structures permit the twist lock grooves 200 to be placed around the bottom portions of the bottle mounting bracket arms 62 as the quick release adapter 69 is rotated into a locked position against the bottle mount bracket 56. In some embodiments, the twist lock grooves 200 include stopping lobes extending downward to secure the arms 62 of an existing bottle mount bracket 56. If present, the stopping lobes prevent full disconnection early in the removal process and allow air pressure to release from bottle when removal is commenced to avoid forceful and possibly dangerous premature ejection of bottle from the mount bracket 56.

Alternative embodiments of quick release adapter 69 will have a different structure at the upper end configured to mate with other styles of bottle mounting bracket 56. For example, an alternative quick release adapter 69 may include male or female threads configured to engage with corresponding but opposite male or female threads formed in the bottle mounting bracket 56.

As noted above, the bottle mounting bracket 56, may be, but is not necessarily, an existing structure attached to a dental operatory chair or other workstation. If a pre-existing system is improved according to this disclosure, the existing bottle 12 may already include a mounting collar attached to the existing bottle 12. Known mounting collars may effectively engage with known bottle mounting brackets, however, known mounting collars can cause problems accessing the interior of a bottle 12 or any associated water uptake tube, filter element, or other structure for replacement or routine maintenance. Therefore, any existing mounting collar is typically removed from the existing bottle 12 before the collar 182 described above is attached. Accordingly, the collar 182 is sometimes referred to as a replacement collar 182.

The end of the quick release adapter 69 opposite the twist lock grooves 200 or other bottle mounting bracket engagement structure will include structure or elements configured to removably engage with the collar 182, preferably without the use of tools. When the quick release adapter 69 is removed from the collar 182 as described below, internal structures including but not limited to water uptake tubes, in-line filters, or treatment assemblies 86 can be easily replaced or maintained.

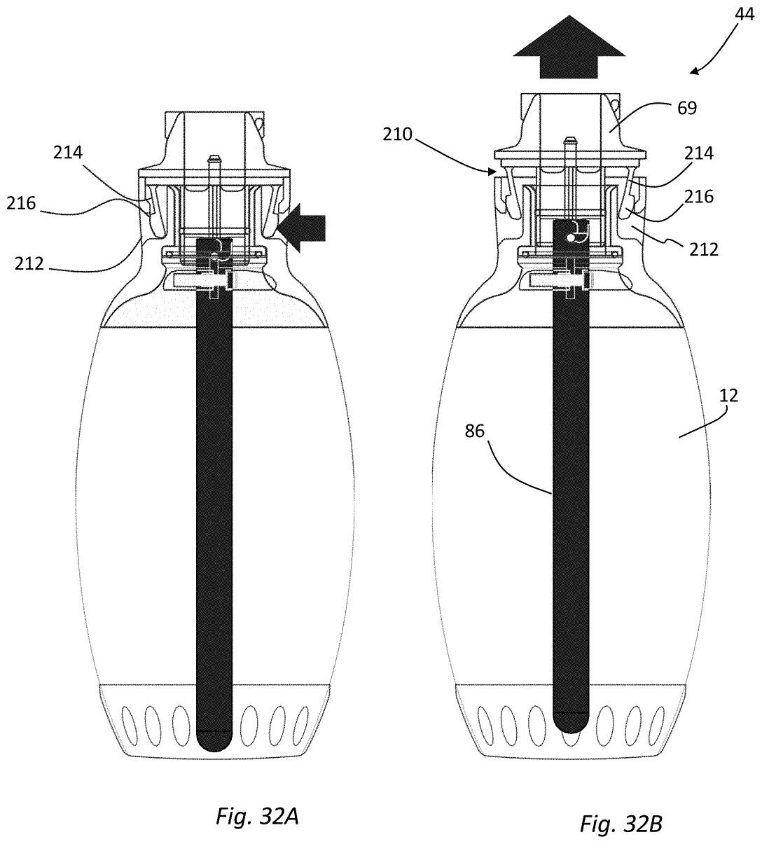

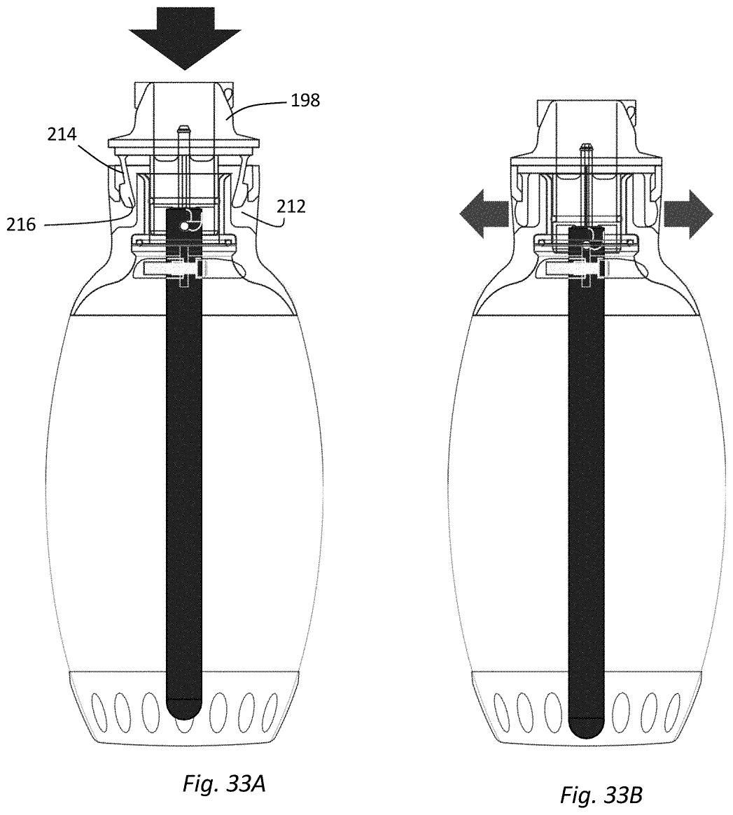

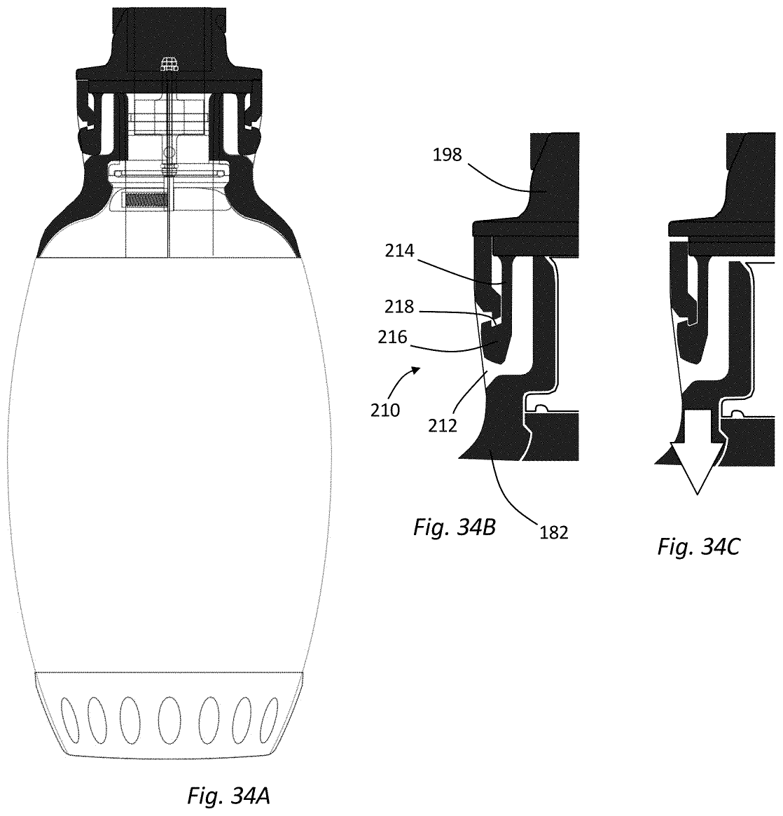

For example, as shown in FIGS. 30 and 32-34, the collar engaging end of the quick release adapter 69 may include one or several pushbutton connectors 210 configured to engage with a corresponding opening 212 in the collar 182. Specifically, as best shown in FIGS. 32 and 33, a pushbutton connector 210 may include a flexible arm 214 and a pushbutton 216 having an engagement surface 218 configured to engage with a corresponding capture surface 220 defined by an opening 212 in the collar 182. Thus, when the quick release adapter 69 is placed into contact with the collar 182 as shown in FIG. 32, the flexible arm 214 of each pushbutton connector 210 flexes within a channel defined by the collar 182, permitting clearance between the pushbutton connector 210 and the capture surface 220 of the opening 212 in the collar 182. As shown in FIG. 33, when the quick release adapter 69 (and any pushbutton connector 210) is fully engaged with the collar 182, recoil of the flexible arm 214 will serve to bias each pushbutton 216 into the corresponding opening 212. In this configuration, the engagement surface 218 on the pushbutton 216 will be fully engaged with the capture surface 220 defined by the opening and the interface between the surfaces will support the weight of a filled bottle 12.

It is important to note that the flexible arm 214 of a pushbutton connector 210 may be fabricated from a material that is inherently flexible. Alternatively, the flexible arm 214 may have hinges, springs, flexible portions, or other structure permitting a pushbutton connector 210 to operate as described herein. Also, in certain embodiments, the engagement surface 218 and/or capture surface 220 may define or include grooves, edges, ledges, undercuts, bevels, or other shaped surfaces configured to lock these surfaces 218, 220 together under the downward force provided by the weight of the bottle 12. This functionality can secure the bottle 12 and collar 182 assembly from unintentional disengagement with the quick release adapter 69. If optional locking structures are provided on the engagement surface 218 and capture surface 220, the quick release adapter 69 must be moved a short distance downward before disengaging any pushbutton 216 from the opening 212 in the collar 182. If locking structures are not provided, the bottle 12 and collar 182 assembly may be disengaged from the quick release adapter 69 without any initial movement.

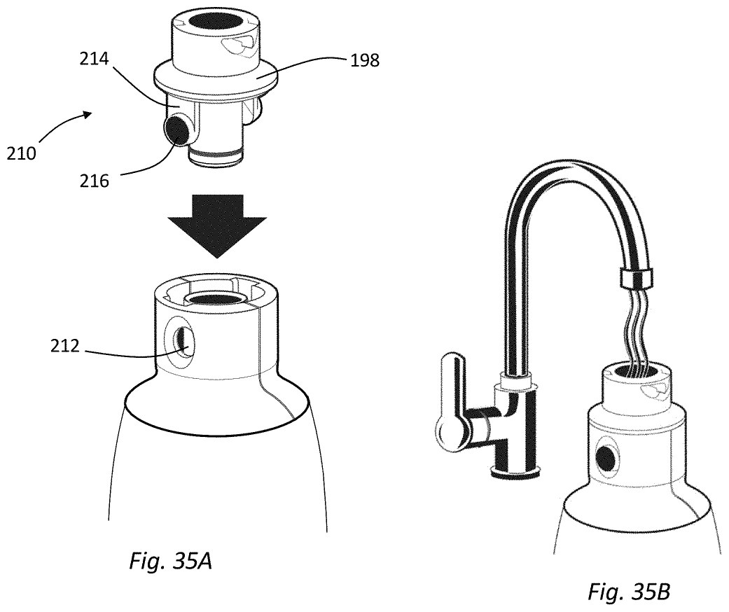

As noted above, it is necessary that the interior of a bottle 12 and any associated apparatus be accessible for routine maintenance or replacement. With the disclosed embodiments, the entire quick release adapter 69, collar 182, and bottle 12 assembly (along with any ancillary structures within the bottle 12 or attached to the quick release adapter 69) may be removed from the system 10 by simply rotating the upper portion of the quick release adapter 69 out of engagement with the bottle mounting bracket. As shown in FIG. 35, the entire quick release adapter 69, collar 182, and bottle 12 assembly may be refilled from a conventional tap through an upper opening in the quick release adapter 69. Periodically, the entire quick release adapter 69, collar 182, and bottle 12 assembly may be taken to a convenient location, for example a back-office workbench for maintenance operations. Most importantly, the quick release adapter 69 may be easily removed from the collar 182 and bottle 12 using the pushbutton connectors 210.

Specifically, disengagement of the quick release adapter 69 from the collar 182 may be accomplished by pressing the pushbuttons 216 inward against the resistance provided by the flexible arm 214 of the pushbutton connector 210. This process is best illustrated in FIG. 32. When the engagement surface 218 and capture surface 220 are fully disengaged, the quick release adapter 69 and any internal structures attached to the quick release adapter 69 may be easily removed from the bottle 12 and collar 182 assembly. Reinstallation is easily accomplished by reversing the above steps.

The embodiment illustrated in the figures includes two opposing pushbutton connectors 210 descending from the quick release adapter 69. The opposing pushbutton connectors 210 correspond to two opposing openings 212 defined in the collar 182. This configuration is not limiting. This configuration is, however, particularly easy to use since dental office personnel can support the bottle 12 with one hand, while simultaneously depressing the two opposing pushbuttons 216 with a finger and thumb of the other hand. It is important to note that both the removal and installation of a quick release adapter 69 from a bottle 12 and collar 182 assembly can be completed without rotating the bottle 12 and without the use of tools.

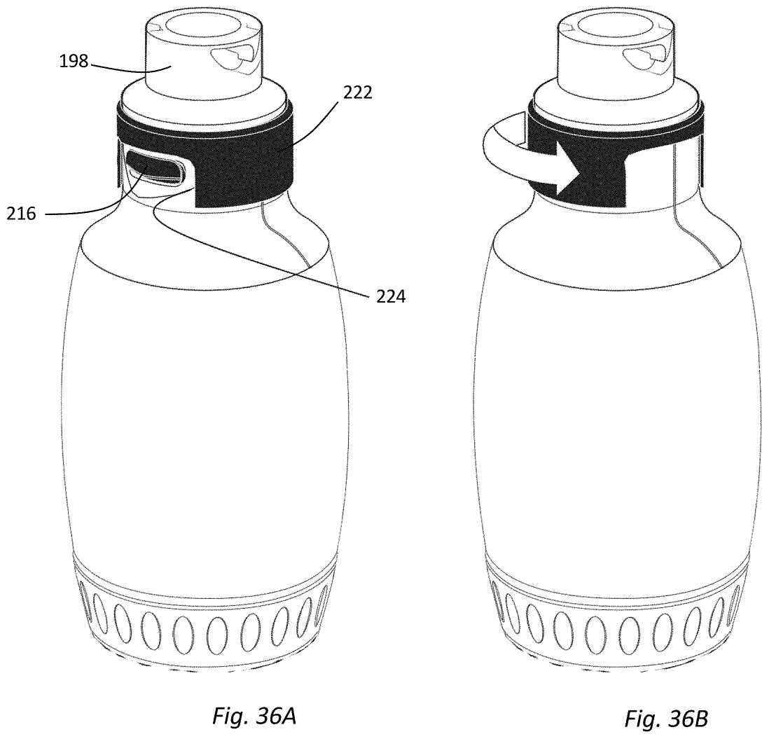

As shown in FIG. 36, the collar 182 may include an optional exterior safety guard 222 having an access window 224. During normal operations, the exterior safety guard 222 may be rotated around the quick release adapter 69 such that the access window does not correspond with a pushbutton 216. In this configuration, the bottle 12 cannot inadvertently be removed from the quick release adapter 69. When it is necessary to remove the quick release adapter 69 from the bottle 12 and collar 182 assembly, the exterior safety guard 222 may be rotated such that the access window 224 corresponds to a pushbutton 216. Thus, access to any pushbutton 216 may be provided or prevented as desired, without the use of tools.

The apparatus described above provides for ready and tool-free access to structures such as water uptake tubes or filters which in use are positioned within the bottle. For example, as shown in FIG. 30, the quick release adapter 69 may include a hose barb 226 formed or installed in a bottle-facing surface. This hose barb 226 can connect to a short piece of tubing or another typically flexible connector 228 which in turn connects to a treatment assembly 86 or a simple water uptake tube (not shown).

The hose barb 226 may be molded or co-formed as an integral part of the of the quick release adapter 69. Alternatively, enhanced durability may be provided by utilizing a separate metal hose barb 226 which is permanently bonded to the typically plastic quick release adapter 69. In addition, any separate metal hose barb 226 may be extended through the quick release adapter 69 to include an attachment point at the upper end for connection to a water line extending through the bottle mounting bracket 56. In each of these embodiments, the hose barb 226 is the entry point of a water channel extending through the quick release adapter 69.

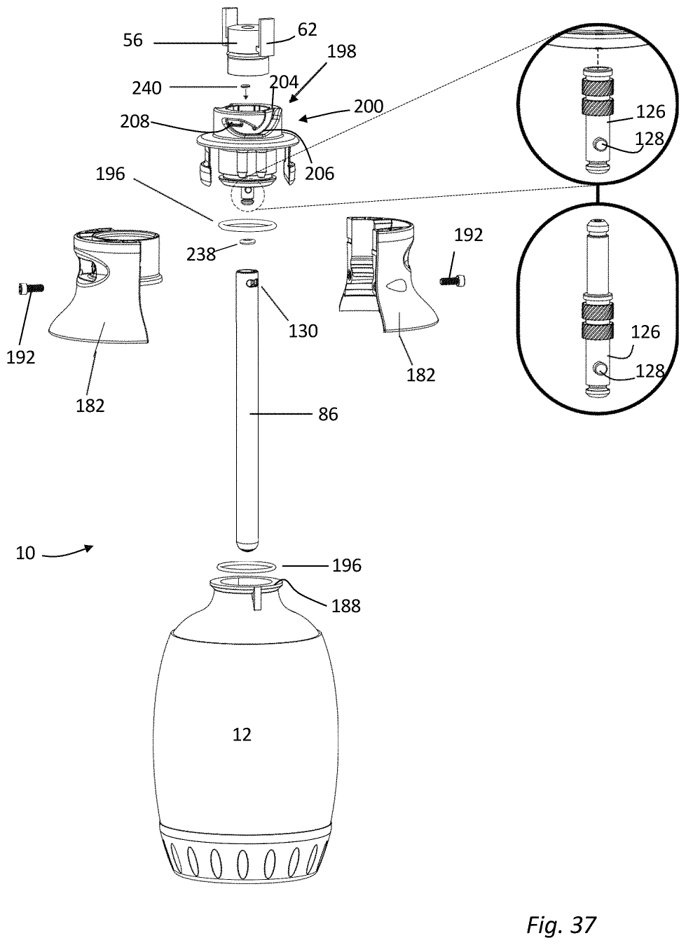

As noted above, any style of hose barb 226 may be connected to a simple water uptake tube or connected to a treatment assembly 86 with a flexible connector 228. The treatment assembly 86 may be a tube or filter element which provides for the mechanical filtration or chemical treatment of water in the bottle 12. Biological contaminants will tend to foul any water uptake tube or treatment assembly 86 over time. Thus, these elements must be removed periodically for servicing. In embodiments featuring a hose barb 226 and flexible connector 228 the treatment assembly 86 or water uptake tube may be separated from the quick release adapter 69 by physically forcing the flexible connector 228 off the hose barb 226, or by cutting the flexible connector 228. As shown in FIGS. 37-39, alternative embodiments include structure which facilitate the removal from and reinstallation of a treatment assembly 86 or water uptake tube without undue force or cutting.

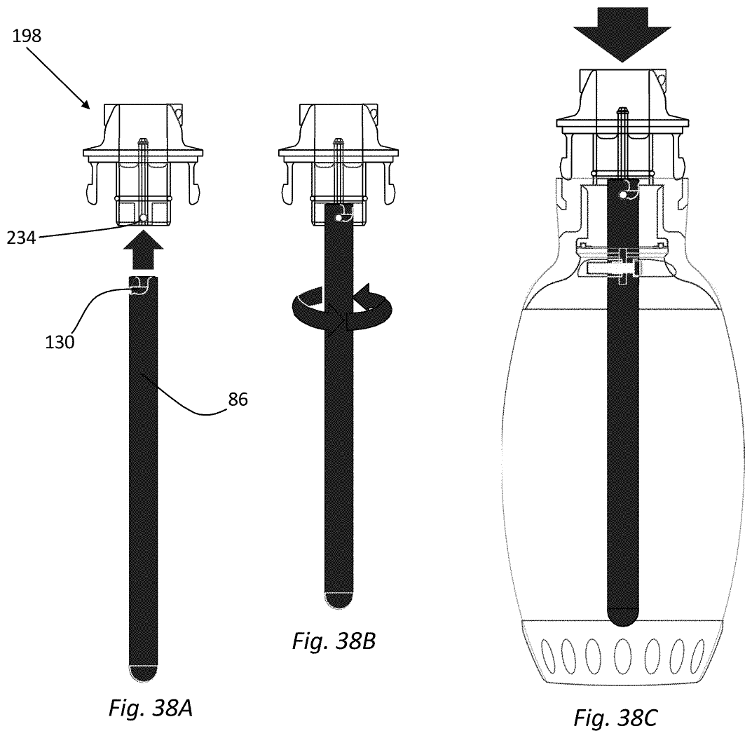

For example, the hose barb 226 extending from the quick release adapter 69 is, in the FIG. 37-39 embodiments, replaced with a generally cylindrical adapter 126 having an engagement stud 128 extending out from the adapter 126. Any treatment assembly 86 or water uptake tube used with these embodiments may include an engagement channel 130 which opens at the top edge of the generally cylindrical tube. As best shown in FIG. 38, a treatment assembly 86 or water uptake tube may be engaged with the cylindrical adapter 126 by sliding the treatment assembly 86 or water uptake tube over the cylindrical adapter such that the engagement stud 128 is received in the engagement channel 130. Then, the treatment assembly 86 or water uptake tube may be twisted or rotated slightly to lock the assembly 86 or uptake tube into place. As shown in FIG. 37, the adapter 126 may include an adapter O-ring 238 in an appropriate groove formed in the adapter 126 to provide a watertight seal with the treatment assembly 86 or water uptake tube.

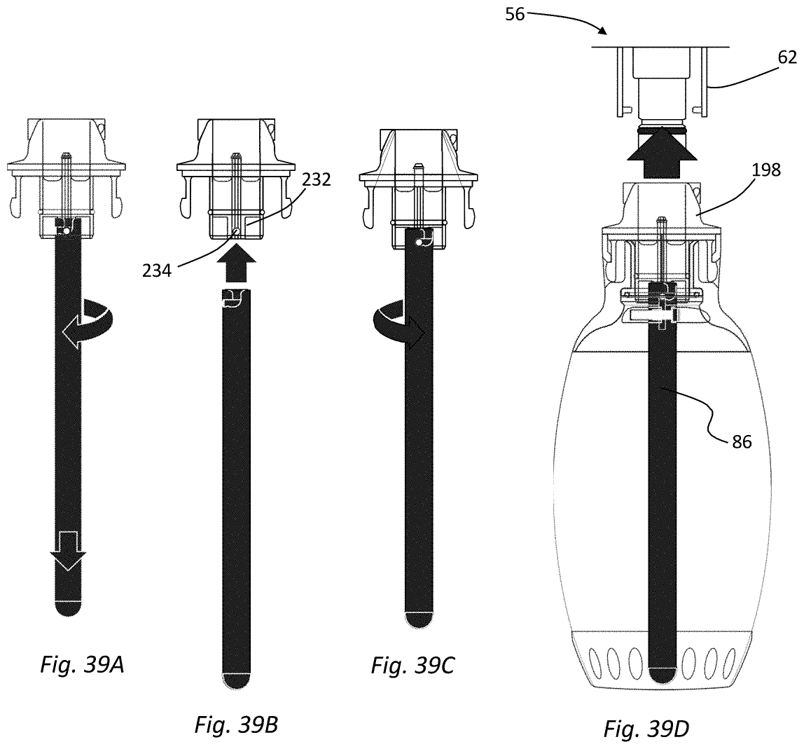

As illustrated in FIG. 39, a cylindrical adapter 126 and associated apparatus as described above permits various types of special-purpose treatment assembly 86 to be easily attached and removed from the system 10 without the use of tools. For example, when necessary, a chemically active shock treatment assembly 86 may be attached to the cylindrical adapter 126 to eliminate or reduce any biofilm growing within the bottle 12. Alternatively, a mechanical or chemical treatment assembly 86 may be attached to the adapter 126 for normal operation. The adapter 126 and associated apparatus permit these and other special-purpose treatment assemblies 86 to be attached to the system, and removed, without the need to cut any connector or otherwise risk of damaging any part.

In addition to the above-described structures which enhance the ease of servicing a dental water supply system 10, the system 10 may include various O-rings, gaskets, seals, or internal channels necessary to transport water from the interior of the bottle to a dental appliance or tool. These ancillary structures include but are not limited to one or more water and/or air channels through the body of the quick release adapter 69, an O-ring 240 sealing the interface between the quick release adapter 69 and bottle mounting bracket 56 and a similar but appropriately sized O-ring 242 to seal the interface between the quick release adapter 69 and the collar 182 or central column 194. As noted above, O-ring 196 may seal the interface between the bottle flange 188 and a lower surface of the quick release adapter 69. Additional seals, gaskets, O-rings, openings, connectors, or channels may be provided as necessary.

In summary, the various embodiments disclosed herein permit dental office personnel to remove from a bottle mounting bracket 56, as one connected assembly, a bottle 12, collar 182 or replacement collar 182, quick release adapter 69, and all internal apparatus. Removal of the assembly may be accomplished without the use of tools. The bottle 12, collar 182, quick release adapter 69 assembly can be conveniently refilled with water without disassembling these parts. In addition, the quick release adapter 69 may be removed from the bottle and collar assembly 12, 182 without the use of tools. This provides dental office personnel with convenient access to any water uptake tube, treatment assembly 86, other filter, or other internal element for maintenance operations. Certain embodiments include treatment assemblies 86 or water uptake tubes which may be easily removed or replaced by disengaging these elements from the quick release adapter 69 at a cylindrical adapter 126 which does not require the use of tools. Reassembly of all described elements and remounting to a bottle mounting bracket may also be accomplished easily and without the use of tools.

2. Adapters for Mounting Brackets with a Threaded Socket

Many dental water supply systems 10 are originally supplied with a supply bottle having a relatively narrow neck and conventional, male threads at the top of the neck. These systems 10 include a threaded socket within, or associated with, the dental operatory chair, dental workstation, or another location. In use, the conventional bottle is threaded into the female socket after being filled with water. Within the female socket, a conventional system will have at least two openings, with the first opening being from a conduit connecting the female socket to an air supply, and the second opening being into a separate channel providing water to downstream dental tools.

In a conventional system, the second opening typically includes a hose barb or similar connector which can be connected to a simple uptake tube or straw which extends within the bottle toward the bottom. In use, pressurized air is supplied through the first opening, which forces water up through the uptake tube, through the second opening, and to downstream equipment.

In many dental water supply systems, the female socket, and corresponding threaded opening on a mating water bottle have a relatively narrow axial diameter. Thus, it is difficult or impossible with these systems to include any sort of treatment assembly 86 within a conventional bottle that has an axial diameter greater than the bottle neck opening. In addition, threaded bottles are not easily removed from threaded sockets. Certain embodiments described below feature adapters which permit the enhanced bottles 12 and treatment assemblies 86 described herein, or similar structures, to be used with dental water supplies 10 having a conventional threaded female socket.

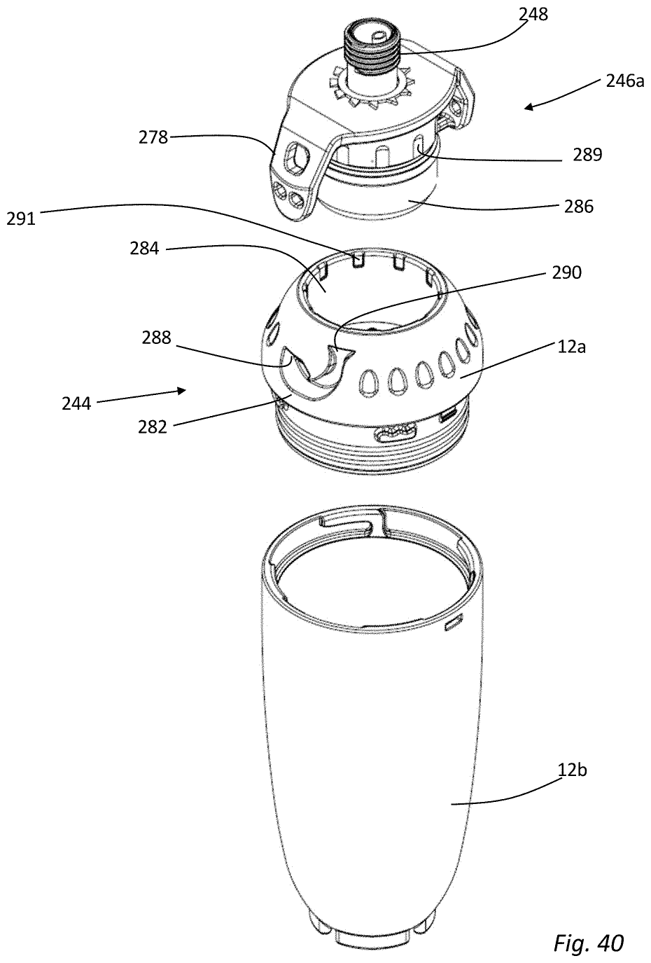

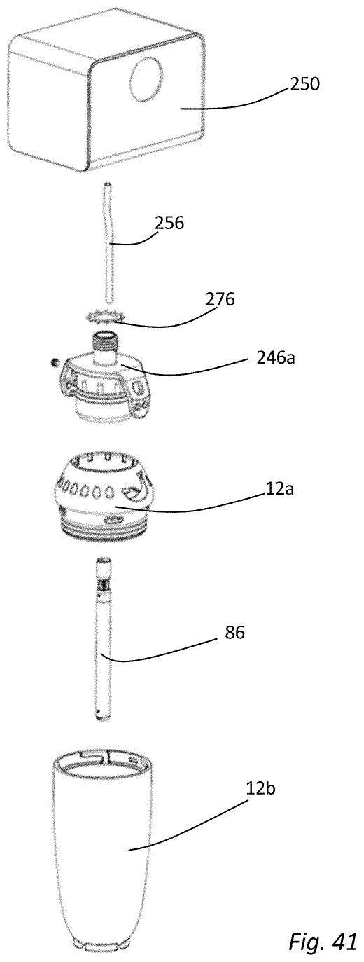

For example, the assembly of FIG. 40 includes a bottle 12 having an upper bottle portion 12a and lower bottle portion 12b like described above with respect to FIGS. 6-7. The FIG. 40 bottle embodiment, however, includes quick release attachments structures 244 molded or formed directly into the upper bottle portion 12a. The assembly of FIG. 40 also includes a threaded adapter 246a which includes male threads 248 extending upward, which male threads 248 are sized and have a pitch selected to permit the threaded adapter 246a to be threaded into engagement with a conventional female threaded dental water supply socket 250 on an existing dental operatory chair, workstation, or other dental equipment. FIG. 41 is an exploded view, which shows the above elements prior to assembly or attachment to the female socket assembly 250 of the dental water supply system of new or existing dental equipment.

As noted above, the female socket assembly 250 will include at least an air outlet 252, and a water inlet 254. The water inlet 254 is typically connected through a hose barb to an uptake tube or other relatively thin water uptake straw extending into the conventional bottle. The threaded adapters 246 disclosed herein provide various structures and internal channels to provide a fluid pathway between the air outlet 252 and the interior of an enhanced bottle 12 and to provide a sealed fluid pathway between the water inlet 254 and any treatment assembly 86 a user desires to position within the bottle 12.

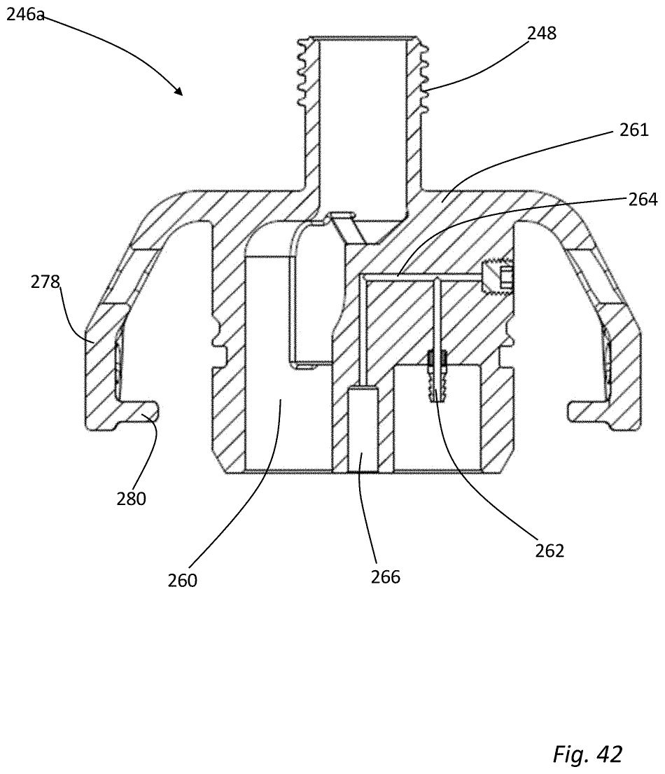

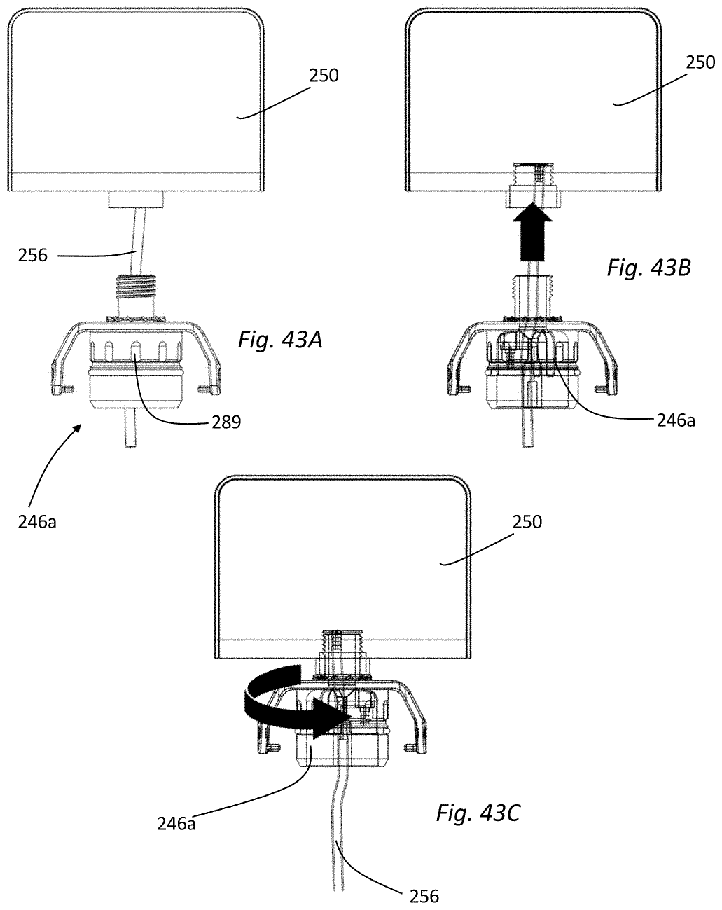

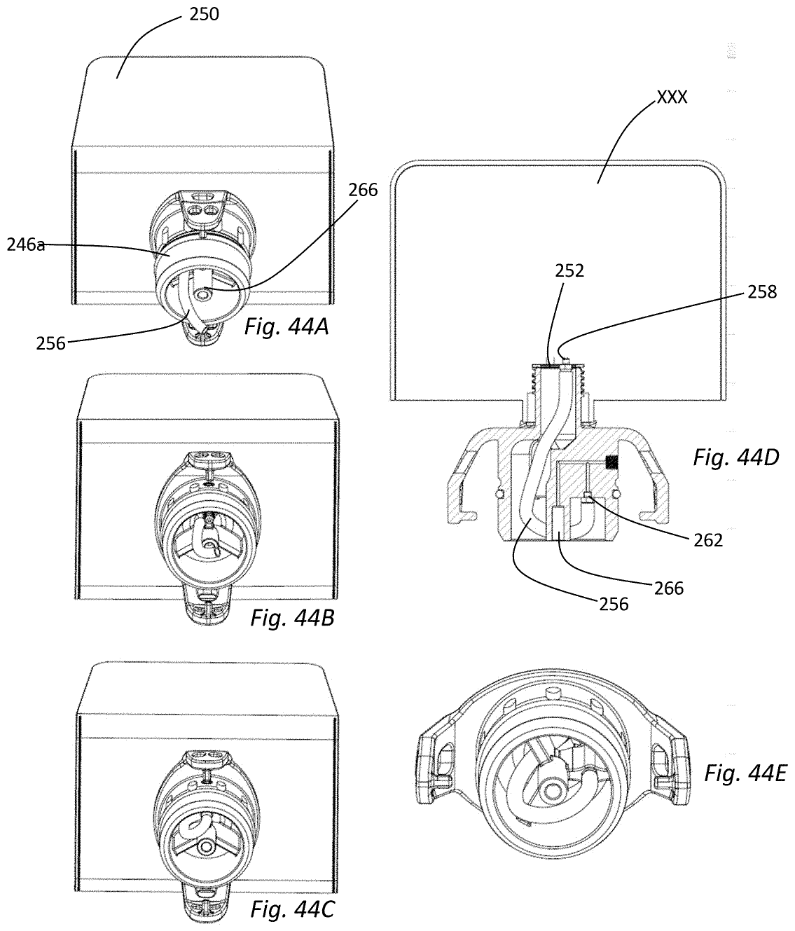

As shown in FIGS. 41-44, one embodiment of threaded adapter 246a provides for air and water flow through the threaded adapter 246a utilizing a flexible tube 256 connected to the water inlet hose barb 258 of the female socket assembly 250. As shown in FIGS. 43 and 44, after one end of the flexible tube 256 is attached to the hose barb 258, the opposite end can be threaded through an internal passageway 260 formed through the body 261 of the threaded adapter 246a. The threaded adapter 246a may then be threaded into engagement with the female socket assembly 250 as shown in FIGS. 43A-C.

After the threaded adapter 246a is fully seated, the opposite end of the flexible tube may then be connected to an adapter hose barb 262 generally extending downward from the underside of the threaded adapter 246a. The adapter hose barb 262 is the exit of a sealed fluid pathway 264 formed within the body 261 of the threaded adapter 246a, and beginning at adapter water inlet 266, also extending downward from the underside of the threaded adapter 246a. As detailed below, the adapter water inlet 266 is configured to engage with mating structures on the upper bottle portion 12a of a bottle 12. In the threaded adapter 246a embodiment, the internal passageway 260 also provides a channel for air to flow from the air outlet 252 through the threaded adapter 246a and into any bottle 12 attached to the threaded adapter 246a as described below.

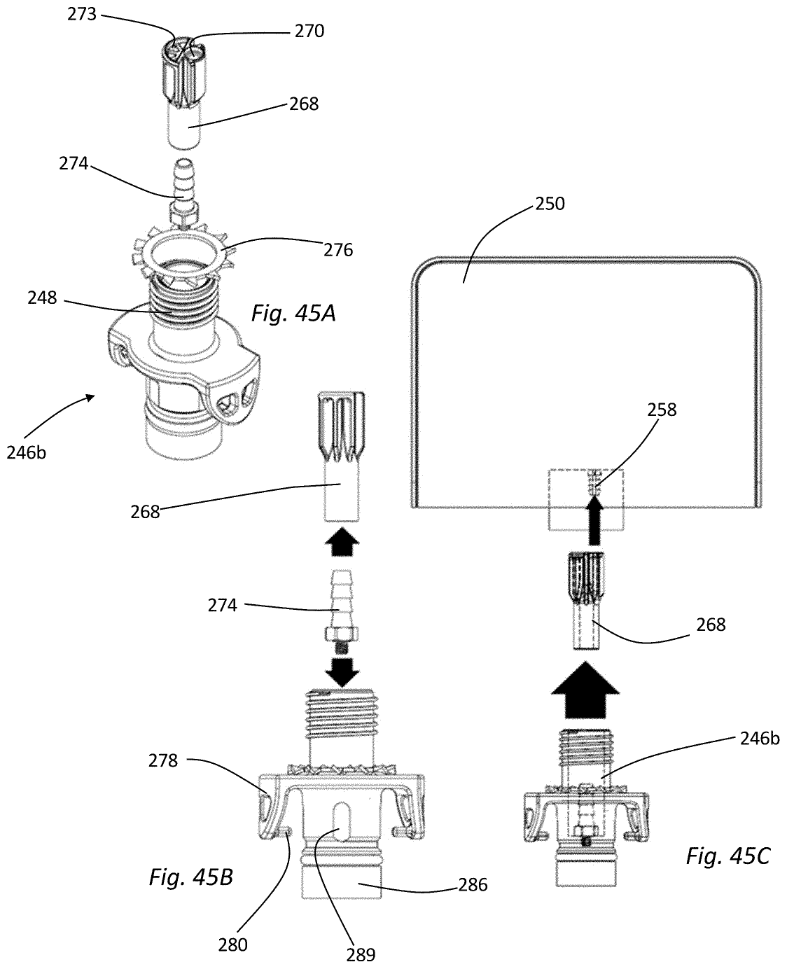

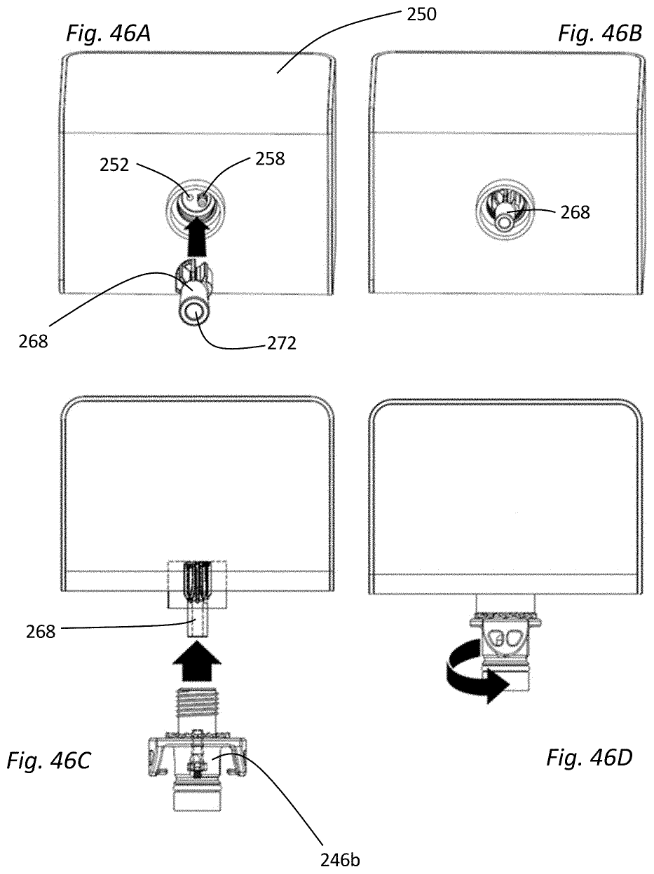

An alternative apparatus for providing suitable air and water pathways through an adapter 246 is shown in FIGS. 45 and 46. In this embodiment, a threaded adapter 246b is provided with a separate connector 268 having an upper connector opening 270. The upper connector opening 270 is formed to make a watertight engagement with the hose barb 258 extending from the female socket assembly 250. Accordingly, the upper connector opening 270 may include one or more O-rings, gaskets or other assemblies to provide a watertight connection with the hose barb 258. The connector 268 defines a sealed water pathway extending generally axially through the connector 268 from the upper connector opening 270 to a lower connector opening 272. The connector 268 may also define one or more air channels 273 extending from or around the exterior surface of the connector 268 and into the threaded adapter 246b.

As shown in FIGS. 45A-C, the lower connector opening 272 of the connector 268 may be engaged with one or more barbs 274 which provide a sealed water pathway from the underside of the threaded adapter 246b through one or more tubes or barbs 274, the connector 268 to the upper connector opening 272. Alternatively, an extended length connector 268 may be formed to directly connect to a mating structure in an upper bottle portion 12a opposite the upper connector opening 272.

As shown in FIG. 46, a threaded adapter 246b may be installed by placing the connector 268 into sealed engagement with the water hose barb 258 extending within the female socket assembly 250. Then, the threaded adapter 246b, may be threaded over the connector 268 into engagement with the female socket assembly 250. Any type of threaded adapter 246 may include a toothed washer 276, or other structure serving to prevent inadvertent disengagement of the adapter 246 from a female socket assembly 250.

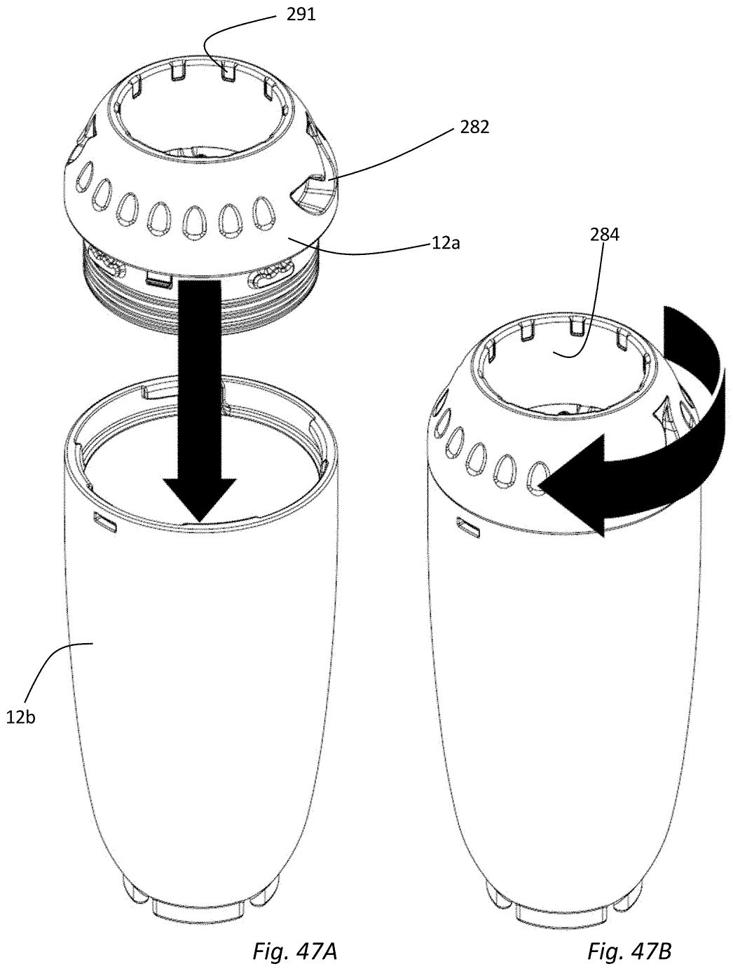

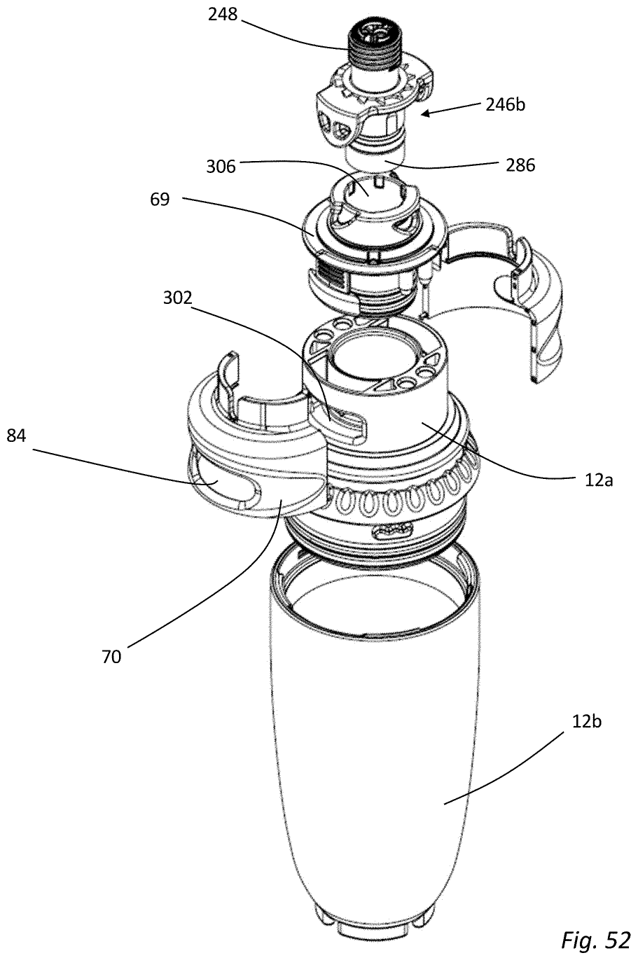

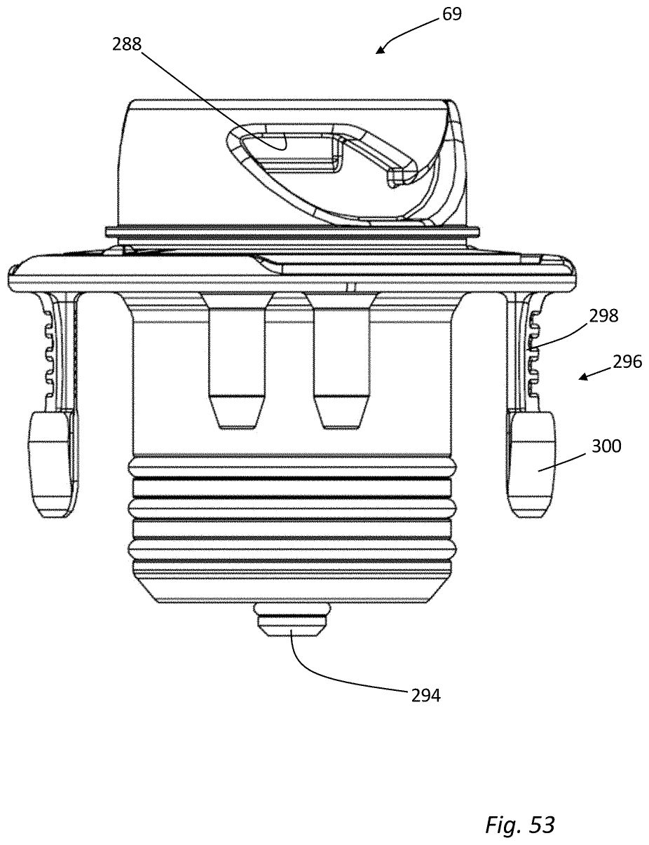

Each of the illustrated threaded adapters 246a and 246b include structure to securely mount a bottle 12 to the threaded adapter 246. Specifically, the illustrated embodiments include downward facing arms 278 extending from the adapter body 261. The arms 278 included attachment fingers 280 at or near the end of each arm 278 away from the adapter body 261. In use, the fingers 280 engage with a slotted attachment structure 282. As shown in FIGS. 40, 41, and FIGS. 47-51 the slotted attachment structure 282 may be formed directly in the bottle 12 or upper bottle portion 12a. Alternatively, the slotted attachment structure 282 may be formed in a separate quick release bottle adapter 69 which is similar in structure and function to the quick release adapters 69 described above. This configuration is illustrated in FIGS. 52-54 and is described in detail below.

Returning to the embodiment of FIGS. 40, 41, and FIGS. 47-51 where the slotted attachment structure 282 is formed directly in an upper bottle portion 12a, it may be noted with reference to FIGS. 49A-C that an assembled bottle 12 may be mounted to the slotted attachment structure 282 by pressing an upper bottle opening 284 formed in the upper bottle portion 12a over the lower cylinder 286 of the threaded adapter 246a, with the fingers 280 engaged with the slotted attachment structure 282. Then, the bottle 12 is rotated a short rotational distance with the fingers 280 sliding within the slotted attachment structure 282. It is important to note that the threaded adapter 246a or 246b will typically include adapter-side air release channels 289 formed in the adapter body. Likewise, as shown in FIG. 40, the upper bottle portion 12a, or a quick release adapter 246b, can include corresponding bottle-side air release channels 291. See FIGS. 40, 3 and 9A). and During use, the bottle is full of water and pressurized air. The air release channels align with each other part way through the rotational motion used to disengage the fingers 280 from the slotted attachment structure 282 located on an adapter 69 or an upper bottle portion 12a. When the air release channels 289 and 291 are aligned, the airtight seal between the bottle and either adapter is broken, and the system is depressurized, while it is still safely attached to the adapter fingers 280 or another mounting structure.

The bottle mounting process is complete when each finger 280 is engaged with a corresponding seating region 288 of the slotted attachment structure 282 away from an entrance 290 to the slotted attachment structure 282. The bottle 12 may be removed by reversing the above process while releasing air as described above using the air release channels 289, 291 or another method. While the dental water system 10 is under pressure, each finger is held firmly within the corresponding seating region 288, limiting or preventing inadvertent bottle removal.

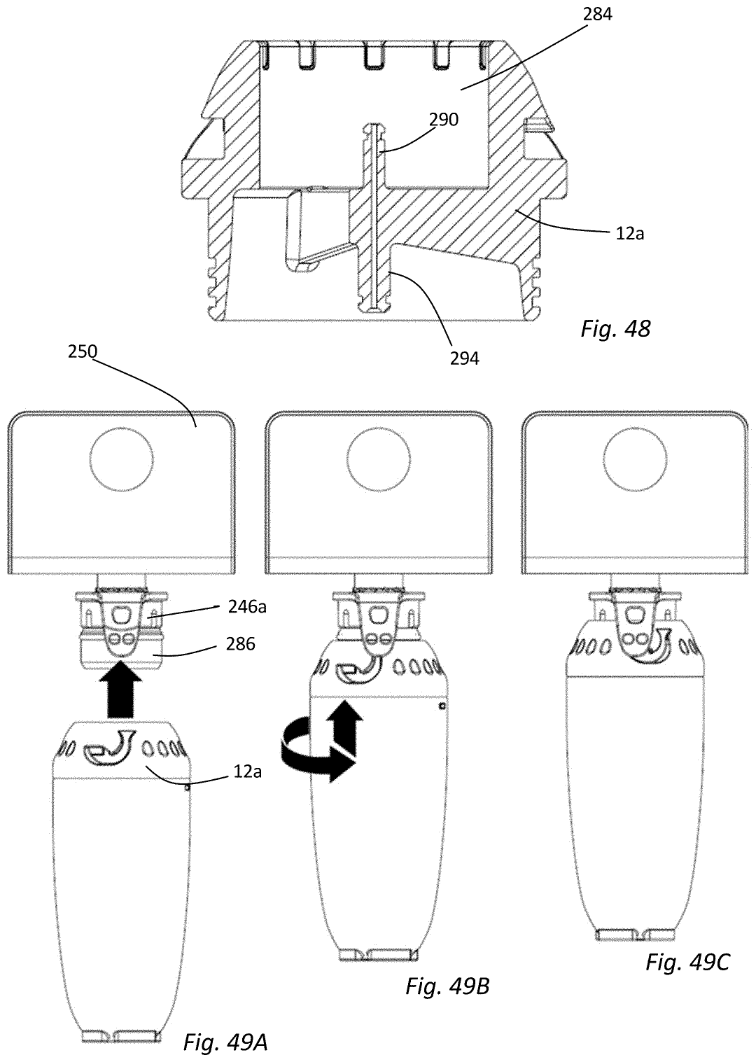

The upper bottle opening 284, the lower cylinder 286, or both can include gaskets, O rings, mating surfaces, or similar structures to provide a watertight seal between the upper bottle portion 12a and the lower cylinder 286 of the threaded adapter 246a. In addition, a water channel from the bottle 12 to the adapter water inlet socket 266 must be provided. In the embodiment of FIGS. 40, 41, and FIGS. 47-51, as best shown in FIG. 48, the upper bottle portion 12a may have an upper water channel extension 290 mounted to, formed in, or otherwise extending toward the threaded adapter 246a, and positioned to be received within the adapter inlet socket 266 when a bottle 12 is mounted to the adapter 246a. One or both of the water channel extension 290 and adapter inlet socket 260 may include O-rings, gaskets or similar structures providing a watertight seal.

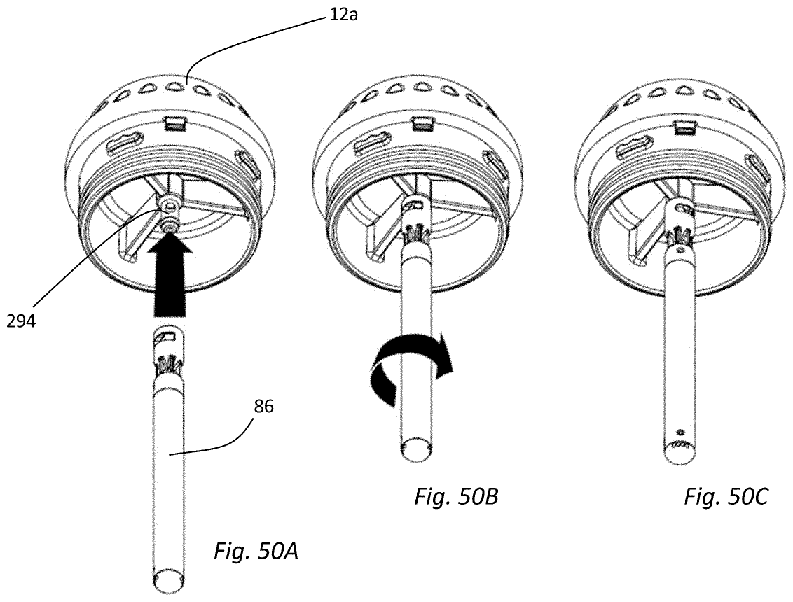

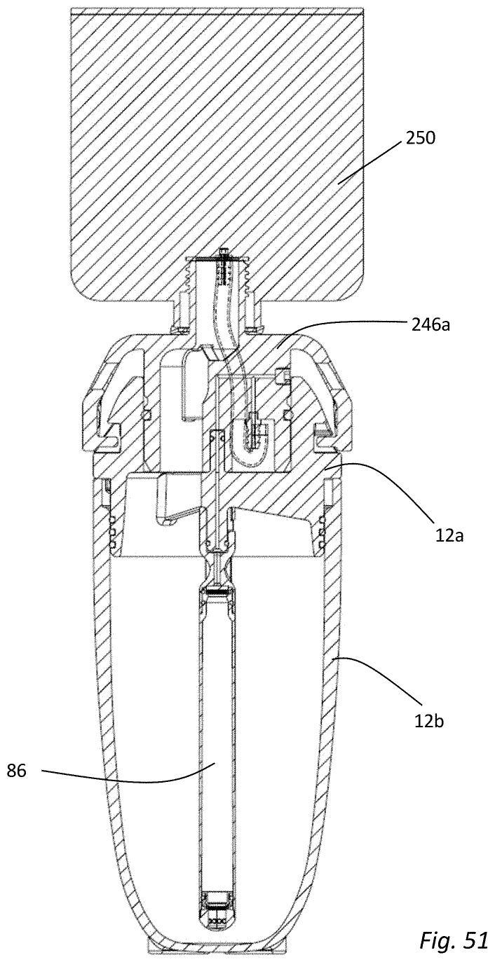

Opposite the upper water channel extension 290 on the threaded adapter 246a is a lower mounting stud 294 positioned to extend into the upper opening 284 of the bottle 12. The lower mounting stud 294 can have any configuration disclosed herein, or similar configurations, suitable for mounting a selected treatment assembly 86 to the underside of the upper bottle portion 12a. For example, as illustrated in FIG. 50, a treatment assembly 86 mat be engaged with the lower mounting stud 294 using a twist lock assembly. In some embodiments, the upper water channel extension 290 and the lower mounting stud 294 may be co-formed with the upper bottle portion 12a, typically from a plastic material. Alternatively, the upper water channel extension 290 and the lower mounting stud 294 may be a separate component, typically formed of metal and bonded to the plastic upper bottle portion 12a.

Certain bottles, for example the bottle 12 of FIG. 6 do not include a slotted attachment structure 282 molded or otherwise formed in the upper bottle portion 12a. In these embodiments, a quick release bottle adapter 69 may be provided which functions much like the quick release adapter 69 described in detail above.

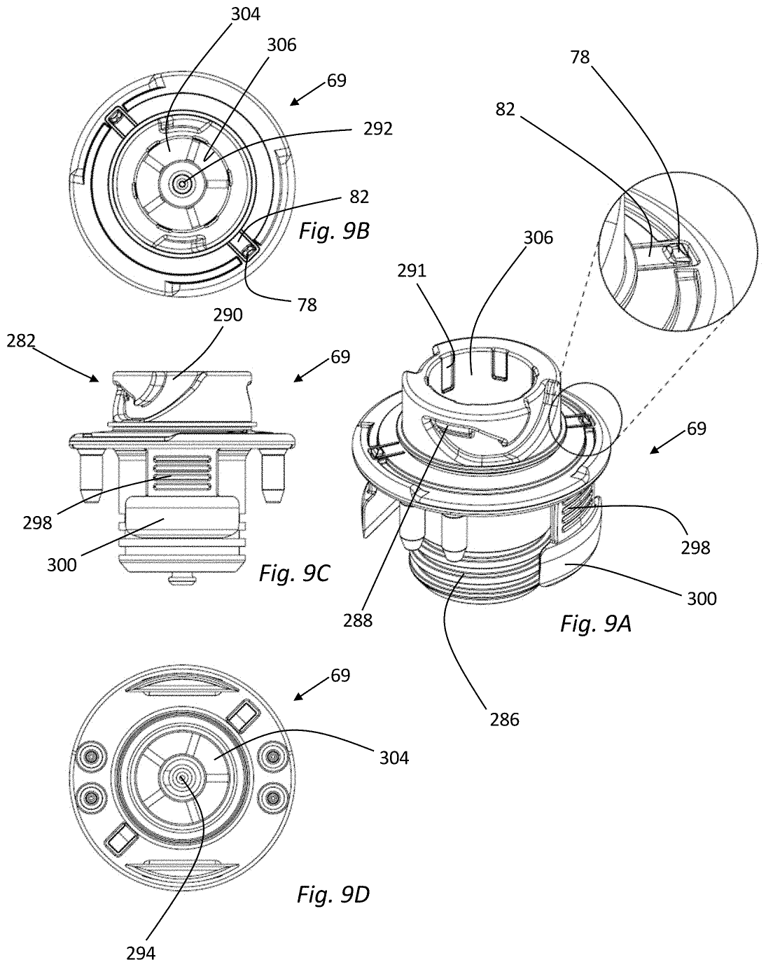

For example, the quick release bottle adapter 69 shown in FIGS. 9, 10, 54 and 55 includes one or more slotted attachment structures 282 configured to engage with the fingers 280 of a threaded adapter 246b. Each slotted attachment structure 282 includes one or more slots having an entrance 290 and seating region 288 as described above. The lower portion of the quick release bottle adapter 69, opposite the slotted attachment structure 282 will include structure or elements configured to removably engage with the upper opening 284 of a suitable bottle 12, preferably without the use of tools.

As shown in FIGS. 9, 52 and 53, the bottle engaging portion of the quick release bottle adapter 69 may include one or several pushbutton connectors 296 configured to engage with a corresponding button opening 302 in the upper bottle portion 12a of the bottle 12. Each pushbutton connector 296 may include a flexible arm 298 and a pushbutton 300 configured to engage with the corresponding button opening 302 defined by the upper portion 12a of the bottle 12. Thus, when the quick release bottle adapter 69 is placed into contact with the bottle 12 as shown in FIG. 10, the flexible arm 214 of each pushbutton connector 210 flexes within the upper opening 284 of the upper bottle portion 12a until each pushbutton 300 is engaged with a corresponding button opening 302.

It is important to note that the flexible arm 298 of a pushbutton connector 296 may be fabricated from a material that is inherently flexible. Alternatively, the flexible arm 298 may have hinges, springs, flexible portions, or other structure permitting a pushbutton connector 296 to operate as described herein. Also, in certain embodiments, the button opening 302 may define or include grooves, edges, ledges, undercuts, bevels, or other shaped surfaces configured to lock the pushbutton 300 and button opening 302 together under the downward force provided by the weight of the filled bottle 12. In addition, the assembly of FIG. 52 may include an access guard 70. The rotating access guard 70 is advantageous, because the access guard includes one or more windows 84. When the access guard 70 is in the first rotational position, the windows 84 can be positioned to block access to any pushbutton 300 preventing accidental disconnection of the water bottle 12 from the quick release bottle adapter 69. Similarly, when the access guard is in a second rotational position, the window 84 is positioned to permit access to the pushbuttons 300 necessary to disconnect the bottle 12 from the quick release bottle adapter 69.

The quick release bottle adapter 69 includes internal fluid pathways for air and water extending from the underside of the quick release bottle adapter 69 to the underside of the threaded adapter 246b. In particular, the quick release bottle adapter includes a downward facing lower mounting stud 294 configured to receive a selected treatment assembly 86. A corresponding upper water channel extension 292 extends from the upper face of the quick release bottle adapter 69 and is received in a mating adapter water inlet socket 266 when a bottle 12 and adapter 69 assembly is engaged with a threaded adapter 246b. As best shown in FIG. 9A and 9, air can communicate from the air outlet 252 of the female socket assembly 250 through the threaded adapter 246b, as described above and then through one or more air channels 304 generally surrounding the lower mounting stud and upper water channel extension structures 294, and 292 respectively.

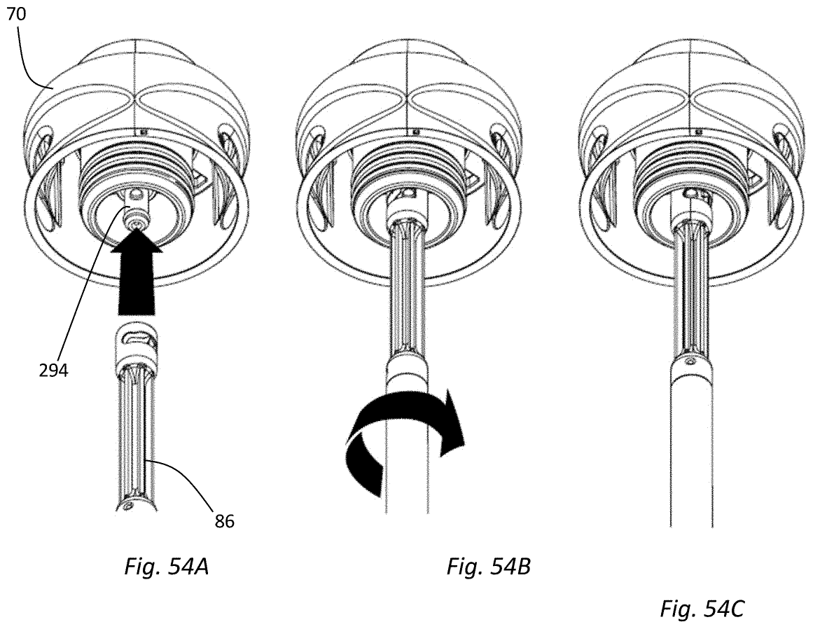

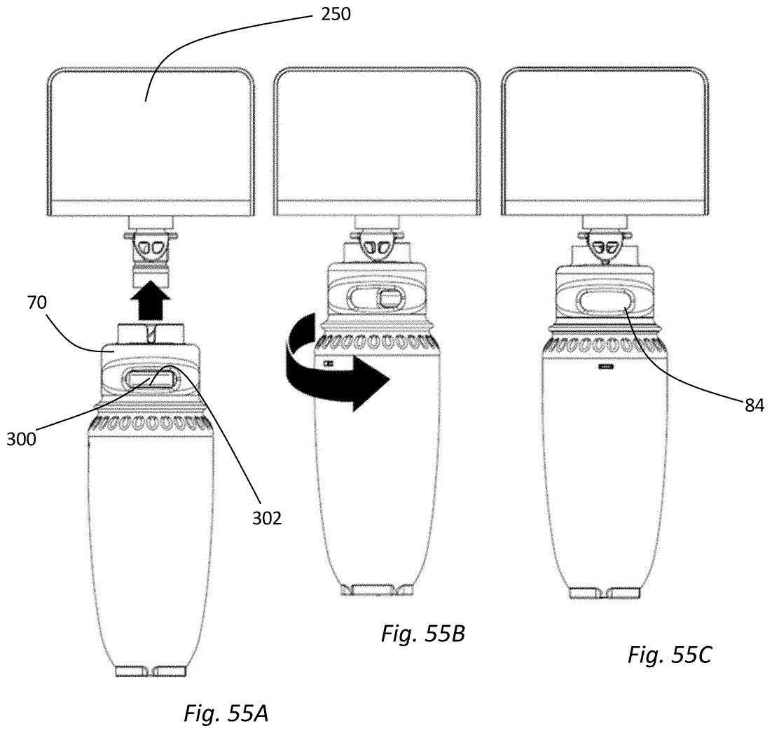

As illustrated in FIG. 54, a selected treatment assembly 86 may be mounted to the lower mounting stud 294. In an embodiment using a separate quick release bottle adapter 69, the treatment assembly 86 may be mounted to the lower mounting stud 294 before or after the quick release bottle adapter 69 is mounted to the bottle 12. As shown in FIG. 55, the assembly of a bottle 12, quick release bottle adapter 69, and access guard 70 may be attached to a threaded adapter 246b without the use of tools by pressing an upper opening 306 in the quick release bottle adapter 69 over the lower cylinder 286 of the threaded adapter 246b. The bottle 12 may then be rotated slightly to fully engage the fingers 280 of the threaded adapter 246b with the slotted attachment structure 282 formed in the quick release bottle adapter 69. The foregoing processes may be reversed to remove the bottle 12 and quick release bottle adapter 69 from the threaded adapter 246a, and to remove the quick release bottle adapter 69 from the bottle 12 to access any treatment assembly 86 for maintenance or replacement.

Having described certain exemplary embodiments, it will be understood by those skilled in the art that many changes in construction and widely differing embodiments and applications of the invention will suggest themselves without departing from the scope of the present invention.

Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system for attaching a dental water supply bottle to a bottle mounting bracket associated with dental equipment, the system comprising:
a collar configured to be attached to a neck region of a dental water supply bottle;
one or more attachment openings defined by the collar; and
an adapter comprising;
one or more mounting bracket attachment slots; and
one or more quick release structures extending from a bottle facing surface on the adapter; wherein the adapter is mounted to the collar by placing the one or more quick release structures into the one or more attachment openings, and wherein the adapter can be disengaged and removed from the collar by manually articulating the quick release structures without the use of tools.

2. The system of claim 1 further comprising:
two quick release structures positioned on opposite sides of the adapter; and
two attachment openings defined on opposite sides of the collar.

3. The system of claim 2 wherein each of the quick release structures comprises:
a flexible arm; and
a pushbutton, wherein the flexible arm biases the pushbutton into a corresponding opening in the collar when the adapter is mounted to the collar.

4. The system of claim 3 further comprising:
an engagement surface defined on each pushbutton; and
a mating capture surface on an edge of the opening; wherein the shape of the engagement surface and the mating capture surface bind each pushbutton to the corresponding opening when the adapter is mounted to the collar.

5. The system of claim 3 further comprising an guard surrounding the collar, wherein the guard defines two access windows, and wherein the guard is rotatable with respect to the collar to cause the two access windows to be positioned over the attachment openings to reveal the pushbuttons, and the guard is further rotatable to cause the two access windows to be positioned away from the attachment openings, concealing the pushbuttons.

6. The system of claim 1 further comprising a hose barb defining a water channel through the adapter, wherein the hose barb comprises:
an upper attachment structure configured to be attached to a water inlet associated with the bottle mounting bracket; and
a lower attachment structure configured to be attached to a treatment assembly or uptake straw extending into the dental water supply bottle.

7. The system of claim 6 wherein the hose barb comprises a separate metal structure bonded to a plastic adapter.

8. The system of claim 6 wherein the lower attachment structure comprises a mounting stud configured to engage with a twist-lock connector.

9. The system of claim 1 wherein the one or more mounting bracket attachment slots are provided with a size and shape that mates with a pre-existing bottle mounting bracket.

10. The system of claim 1 further comprising a threaded adapter comprising:
upward facing male threads sized to engage with a female threaded socket of a dental equipment installation; and
downward facing arms configured to engage with the mounting bracket attachment slots of the adapter.

11. A method of attaching a dental water supply bottle to a bottle mounting bracket comprising:
providing a dental water supply bottle and an original collar assembly;
removing the original collar from the dental water supply bottle;
attaching a replacement collar to the dental water supply bottle, wherein the replacement collar comprises one or more attachment openings;
providing an adapter comprising;
one or more mounting bracket attachment slots; and
one or more quick release structures extending from a bottle facing surface on the adapter;
mounting the adapter to the replacement collar by placing the one or more quick release structures into engagement with the one or more attachment openings; and
mounting the dental water supply bottle, replacement collar, and adapter assembly to the bottle mounting bracket by engaging the one or more bracket attachment slots with the bottle mounting bracket.

12. The method of claim 11 further comprising:
removing the dental water supply bottle, replacement collar, and adapter assembly from the bottle mounting bracket; and
disengaging the adapter from the replacement collar by manually articulating the one or more quick release structures, without the use of tools; and
removing the adapter out of engagement with the replacement collar.

13. The method of claim 11 further comprising:
providing two quick release structures positioned on opposite sides of the adapter; and
providing two attachment openings defined on opposite sides of the replacement collar.

14. The method of claim 13 further comprising:
providing each quick release structure with a flexible arm and a pushbutton; and
biasing each pushbutton into a corresponding opening with the flexible arm when the adapter is mounted to the replacement collar.

15. The method of claim 14 further comprising:
providing an engagement surface on each pushbutton;
providing a mating capture surface on each opening;
binding the pushbutton to the opening when the adapter is mounted to the replacement collar by engagement between the engagement surfaces and the mating capture surfaces; and
removing the adapter from the replacement collar by manually displacing a longitudinal position of the adapter with respect to the replacement collar to disengage the engagement surfaces and the capture surfaces;
manually articulating the pushbuttons, without the use of tools; and
removing the adapter out of engagement with the replacement collar.

16. The method of claim 13 further comprising:
providing a guard surrounding the replacement collar, wherein the guard defines two access windows;
rotating the guard with respect to the replacement collar to position the two access windows over the attachment openings to reveal the pushbuttons; and
rotating the guard with respect to the replacement collar to position the two access windows away from the attachment openings, to conceal the pushbuttons.

17. The method of claim 11 further comprising:
providing the adapter with a hose barb defining a water channel through the adapter:
attaching an upper attachment structure on the hose barb to a water inlet associated with the bottle mounting bracket; and
attaching a treatment assembly or take-up straw to a lower attachment structure on the hose barb to extend into the dental water supply bottle.

18. The method of claim 17 further comprising:
providing the treatment assembly or take-up straw with a twist-lock connector;
providing the lower attachment structure with a mounting stud; and
attaching the treatment assembly or take-up straw to the lower connector by twisting the twist lock connector into engagement with the mounting stud.

19. The method of claim 11 further comprising:
providing a threaded adapter comprising;
upward facing male threads sized to engage with a female threaded socket of a dental equipment installation; and
downward facing arms configured to engage with the mounting bracket attachment slots of the adapter;
threading the threaded adapter into engagement with the female threaded socket; and
mounting the dental water supply bottle, replacement collar, and adapter assembly to the threaded adapter by engaging the one or more bracket attachment slots with the arms of the threaded adapter.
